(19) United States
(12) Patent Application Publication
(10) Pub. No.: US 2007/0294686 A1
(43) Pub. Date: Dec. 20, 2007

(54) PROGRAM UPGRADE SYSTEM AND METHOD FOR OTA-CAPABLE DEVICE

(75) Inventor: Sung Jo OH, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/765,214

(22) Filed: Jun. 19, 2007

(30) Foreign Application Priority Data
Jun. 19, 2006 (KR) 2006-0054746

(51) Int. Cl. G06F 9/44

(52) U.S. Cl. 717/168

(57) ABSTRACT

A system and method for updating a program of a mobile device using an over-the-air programming mechanism is provided and adopted to a network including an upgrade package processor for generating an upgrade package for a program and an upgrade package server allowing a recipient device to download the upgrade package. The program upgrade method of the present invention includes generating, at the upgrade package processor, the upgrade package on the basis of differences between a first and second versions of the program; notifying, at the upgrade package server, at least one recipient device of an issuance of the upgrade package; downloading, at the recipient device, the upgrade package from the upgrade package server; installing the upgrade package in a non-volatile memory; generating the second version of the program by merging the upgrade package and the first version previously installed in the nonvolatile memory; and loading the second version on a volatile memory in response to an upgrade command.

### PRIORITY

This application claims priority under 35 U.S.C. §119 to Korean Patent Application No. 2006-0054746, which was filed in the Korean Intellectual Property Office on Jun. 19, 2006, the contents of which are incorporated herein by reference.

### BACKGROUND OF THE INVENTION

1. Field of the Invention

The present invention relates to a system upgrade method and, in particular, to a system and method for updating a program (including an operating firmware and application software) of a mobile device using an over-the-air programming mechanism.

2. Description of the Related Art

Electronic devices, such as mobile phones and personal digital assistants (PDAs), contain firmware and application software that are provided by the manufacturers of the electronic devices, telecommunication carriers, or third parties. Such firmware and application software may contain software bugs and require version upgrades. In order to fix and upgrade the firmware and application software, a user visits a customer care center operated by the manufacturer or the carrier. In the case of an over-the-air (OTA) capable device, the firmware or software upgrade can be performed by the OTA mechanism in which the firmware or software upgrades are distributed to the devices over the air.

In order to use the OTA upgrade process, the electronic device incorporates a download module for downloading an upgrade package and an upgrade processing module for performing the upgrade of target firmware or software with the downloaded upgrade package. However, most conventional OTA capable devices are limited in OTA operation stability.

### SUMMARY OF THE INVENTION

The present invention has been made in an effort to solve at least the above problems, and the present invention provides a firmware upgrade system and method for an OTA-capable device that enable upgrading firmware using an upgrade package received over the air.

The present invention provides a firmware upgrade system and method for an OTA-capable device that enable the independent storage of an initial version of firmware and at least one upgrade package of the firmware received over the air and upgrading the firmware using the initial version and a selected upgrade package.

The present invention provides a firmware upgrade system and method for an OTA-capable device that enable upgrading firmware using an initial version and at least one upgrade package of the firmware, in response to a system booting instruction or an initialization command, the upgrade package being received over the air, and the initial version and upgrade package being stored independently.

The present invention provides a firmware upgrade system and method for an OTA-capable device that enable upgrading firmware using an upgraded package which is generated by merging history data and upgrade data generated by comparing an initial version and an upgraded version of the firmware.

The present invention provides a firmware upgrade system and method for an OTA-capable device that extracts install data from an upgrade package received over the air, stores the install data and upgrade package in a nonvolatile memory, upgrades an initial version of a firmware with reference to the install data in response to an upgrade command, and loads the upgraded firmware on a volatile memory such that the upgraded firmware operates the device.

In accordance with an aspect of the present invention, the above and other objects are accomplished by a program upgrade method in a network including an upgrade package processor for generating an upgrade package for a program and an upgrade package server allowing a recipient device to download the upgrade package. The program upgrade method includes generating, at the upgrade package processor, the upgrade package on the basis of differences between a first version and a second version of the program; notifying, at the upgrade package server, at least one recipient device of an issuance of the upgrade package; downloading, at the recipient device, the upgrade package from the upgrade package server; installing the upgrade package in a non-volatile memory; and generating the second version of the program by merging the upgrade package and the first version previously installed in the nonvolatile memory; and loading the second version on a volatile memory in response to an upgrade command.

In accordance with another aspect of the present invention, the above and other objects are accomplished by a program upgrade method in a network including an upgrade package processor for generating an upgrade package for a program and an upgrade package server allowing a recipient device to download the upgrade package. The program upgrade method includes generating, at the upgrade package processor, the upgrade package on the basis of differences between a first version and a second version of the program; notifying, at the upgrade package server, at least one recipient device of an issuance of the upgrade package; downloading, at the recipient device, the upgrade package from the upgrade package server; storing the upgrade package in a nonvolatile memory; generating the second version of the program by merging the upgrade package and the first version previously installed in the nonvolatile memory; and loading the second version on a volatile memory in response to an upgrade command, wherein generating the upgrade package comprises comparing the first version and the second version of the program in block units; generating the upgrade data on the basis of a comparison result; generating install data for installing the upgrade data on the basis of the comparison result; and producing the upgrade package by packing the install data and the upgrade data.

In accordance with another aspect of the present invention, the above and other objects are accomplished by a program upgrade method in a network including an upgrade package processor for generating an upgrade package for a program and an upgrade package server allowing a recipient device to download the upgrade package. The program upgrade method includes generating, at the upgrade package processor, the upgrade package on the basis of differences between a first version and a second version of the program; notifying, at the upgrade package server, at least one recipient device of an issuance of the upgrade package; downloading, at the recipient device, the upgrade package from the upgrade package server; storing the upgrade package in a non-volatile memory; generating the second version of the program by merging the upgrade package and the first version previously installed in the nonvolatile memory; and loading the second version on a volatile memory in response to an upgrade command, wherein generating the second version of the program includes installing the downloaded upgrade package in the first memory and producing the second version by loading and merging the first version and the upgrade package in response to an upgrade command.

In accordance with another aspect of the present invention, the above and other objects are accomplished by a program upgrade method in a network including an upgrade package processor for generating an upgrade package for a program and an upgrade package server allowing a recipient device to download the upgrade package. The program upgrade method includes receiving, at the upgrade package processor, a first version and a second version; comparing the first version and the second version; generating upgrade data to be merged with the first version; generating install data for merging the upgrade data and the first version; generating the upgrade package by packing the upgrade data and the install data; notifying, at the upgrade package server, at least one recipient device of an issuance of the upgrade package; downloading, at the recipient device, the upgrade package from the upgrade package server; installing the downloaded upgrade package in a nonvolatile memory; generating the second version of the program by merging the first version and the upgrade package in response to an upgrade command; and loading the second version on a volatile memory for operating the recipient device.

In accordance with another aspect of the present invention, the above and other objects are accomplished by a program upgrade system. The program upgrade system includes an upgrade package processor for generating an upgrade package on the basis of a difference between a first version and a second version of a program; an upgrade package server for receiving the upgrade package from the upgrade package processor and broadcasting an advertisement for notifying an issuance of the upgrade package; and at least one mobile device for downloading the upgrade package in response to the advertisement, storing the upgrade package in a first memory in which the first version is stored, generating the second version by merging the upgrade package and the first version, and loading the second version on a second memory for operating the mobile device.

In accordance with another aspect of the present invention, the above and other objects are accomplished by a program upgrade system. The program upgrade system includes an upgrade package processor for generating an upgrade package on the basis of differences between a first version and a second version of a program; an upgrade package server for receiving the upgrade package from the upgrade package processor and broadcasting an advertisement for notifying an issuance of the upgrade package; and at least one mobile device for downloading the upgrade package in response to the advertisement, storing the upgrade package in a first memory in which the first version is stored, generating the second version by merging the upgrade package and the first version, and loading the second version on a second memory for operating the mobile device, wherein the upgrade package processor includes a comparator for comparing the first version and the second version; an install data generator for generating install data on the basis of the comparison result; and a package generator for generating upgrade data on the basis of the map data and producing the upgrade package by packing the install data and the upgrade data.

In accordance with another aspect of the present invention, the above and other objects are accomplished by a program upgrade system. The program upgrade system includes an upgrade package processor for generating an upgrade package on the basis of differences between a first version and a second version of a program; an upgrade package server for receiving the upgrade package from the upgrade package processor and broadcasting an advertisement for notifying an issuance of the upgrade package; and at least one mobile device for downloading the upgrade package in response to the advertisement, storing the upgrade package in a first memory in which the first version is stored, generating the second version by merging the upgrade package and the first version, and loading the second version on a second memory for operating the mobile device, wherein the mobile device includes an installer for installing the downloaded upgrade package in an upgrade package storage region of the first memory and a translator for generating the second version by mapping the upgrade package to the first version in response to an upgrade command and loading the second version on the second memory.

In accordance with another aspect of the present invention, the above and other objects are accomplished by a program upgrade system. The program upgrade system includes an upgrade package processor having a comparator for comparing a first version and a second version of a program, an install data generator for generating install data for upgrading the first version to the second version, an upgrade package generator for generating upgrade data on the basis of the comparison result and producing an upgrade package by packing the install data and the upgrade data; an upgrade package server for receiving the upgrade package from the upgrade package processor and broadcasting an advertisement for notifying an issuance of the upgrade package; and at least one mobile device having a first memory for storing the first version and at least one upgrade package, a second memory for storing the second version produced using the first version and the upgrade package, an installer for installing the upgrade package downloaded from the upgrade package server within at least one upgrade package storage region of the first memory, and a translator for generating the second version by mapping the upgrade package to the first version and loading the second version in the second memory.

### BRIEF DESCRIPTION OF THE DRAWINGS

The above and other objects, features and advantages of the present invention will be more apparent from the following detailed description in conjunction with the accompanying drawings, in which:

FIG. 1 is a diagram illustrating a program upgrade system according to an exemplary embodiment of the present invention;

FIG. 2 is a block diagram illustrating an operation of the upgrade package processor of the program upgrade system of FIG. 1;

FIG. 3 is diagram illustrating a relationship between first and second versions for generating an upgrade package in the upgrade package processor 10 of FIG. 2;

FIG. 4 is a block diagram illustrating a configuration of an upgrade package processor of a program upgrade system in accordance with an exemplary embodiment of the present invention;

FIG. 5 is a block diagram illustrating a configuration of an upgrade package processor of a program upgrade system in accordance with another exemplary embodiment of the present invention;

FIG. 6A is a diagram illustrating a data format of an upgrade package generated by the upgrade package processor of FIG. 4;

FIG. 6B is a diagram illustrating a data format of an upgrade package generated by the upgrade package processor of FIG. 5;

FIG. 7 is a block diagram illustrating a configuration of an upgrade package processor of a program upgrade system in accordance with another exemplary embodiment of the present invention;

FIG. 8 is a block diagram illustrating a configuration of a recipient device of a program upgrade system according to an exemplary embodiment of the present invention;

FIG. 9 is a block diagram illustrating a configuration of a first memory of a recipient device of FIG. 8;

FIG. 10A is a diagram illustrating a structure of the second storage region of the first memory of FIG. 9;

FIG. 10B is a diagram illustrating a data format of the history data of each upgrade package stored in the second storage region of FIG. 10A;

FIG. 11 is a block diagram illustrating an upgrade operation of a program upgrade system according to an exemplary embodiment of the present invention;

FIG. 12 is a block diagram illustrating an upgrade operation of a program upgrade system according to another exemplary embodiment of the present invention;

FIG. 13 is a block diagram illustrating an upgrade operation of a program upgrade system according to another exemplary embodiment of the present invention;

FIG. 14 is a block diagram illustrating an upgrade operation of the recipient device of the program upgrade system according to an exemplary embodiment of the present invention;

FIG. 15 is a flowchart illustrating a program upgrade method according to an exemplary embodiment of the present invention;

FIGS. 16A to 16C are flowcharts illustrating an upgrade package generation procedure of a program upgrade method according to an exemplary embodiment of the present invention;

FIG. 17 is a flowchart illustrating an upgrade package generation procedure of a program upgrade method according to an exemplary embodiment of the present invention;

FIG. 18 is a flowchart illustrating a compression reliability test procedure of FIG. 17;

FIG. 19 is a flowchart illustrating an install data generation procedure of FIG. 17;

FIG. 20 is a flowchart illustrating an upgrade package generation procedure of FIG. 17;

FIG. 21 is a message flow diagram illustrating a program download procedure of a program upgrade method according to an exemplary embodiment of the present invention;

FIG. 22 is a flowchart illustrating a downloaded upgrade package processing procedure of a program upgrade method according to an exemplary embodiment of the present invention;

FIG. 23 is a flowchart illustrating an upgrade package install procedure of a program upgrade method according to an exemplary embodiment of the present invention;

FIG. 24 is a flowchart illustrating an upgraded program running procedure of a program upgrade method according to an exemplary embodiment of the present invention; and

FIGS. 25A to 25D are flowcharts illustrating an upgrade program running procedure of a program upgrade method according to another exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the following embodiments, a number of the data blocks of upgrade versions and a size of a macroblock are defined only to help in the understanding of the present invention. However, it will be obvious to those skilled in the art that the present invention can be implemented without defining the number and size of the macro blocks or modification thereof.

In the following embodiments, the term “upgrade” defines a process for upgrading information of a system. The “information” is an object to be upgraded and includes programs such as firmware and software and nonvolatile data. The program includes firmware and software, and the non-volatile data include fonts, system image, and user data. In the case where the recipient device is a mobile phone, typically the user data such as subscriber information and multimedia data produced by a user or obtained by purchase can be uploaded to a server. The server compares uploaded data with previous nonvolatile data so as to generate an upgrade package. The upgrade package is downloaded by the mobile phone. In the following description, the information is represented by a program. The program can be firmware or software. The information upgrade is described with the procedure for generating an upgrade package of the program.

The “upgrade package” contains upgrade data and install data. The “upgrade data” is data for used for upgrading old version information to new version information. The install data can include history data for informing a relationship of the upgrade package and the first version and map data for mapping the blocks of the second version to the first version. The map data includes commands such as “copy”, “shift”, “modify”, etc. for creating a new version of the information and block location data for executing the commands. A “first version” means an old version of a target program and is interchangeably referred to as a “reference version.” A “second version” is an upgrade version of the first version of the program. The second version of the program can be an upgrade package created on the basis of difference between the first and second versions of the program. A recipient device is installed with the first version of the software in a manufacturing stage and can download and store at least one upgrade package when an upgrade event occurs. The upgrade package includes install data and upgrade data required for updating the program from the first version to the second version, and particularly, can includes commands “copy”, shift”, and “modify”, and block location data for executing the commands. A “program” can be firmware or application software.

A “first memory” is a memory for storing the first and second versions of the program. A “second memory” is a memory for loading a program upgraded from the first version using the upgrade package represented by the second version. The first and second memories can be implemented with first and second memory regions in a single memory unit or can be implemented as physically separated memory modules. In the following embodiments, the first and second memories are individual memory modules. The first memory is a flash memory as a non-volatile memory, and the second memory is a synchronous dynamic random access memory (SDRAM) as a volatile memory. The first memory stores the first version of the program and at least one upgrade package as the second version of the program. The upgrade package includes history data for identifying versions of the program (including map data) and upgrade data. If an upgrade event occurs by a system initialization or a user command, the system loads into the second memory the second version of the program upgraded using the upgrade package such that the system operates with the second version of the program. At this time, the first version of the program can be the reference version of the program. The second version of the program can be an upgrade package including the install data and upgrade data.

The program upgrade system can be divided into a transmission system for producing and transmitting upgrade packages and a recipient device for receiving the upgrade packages and upgrading a target program with the upgrade packages.

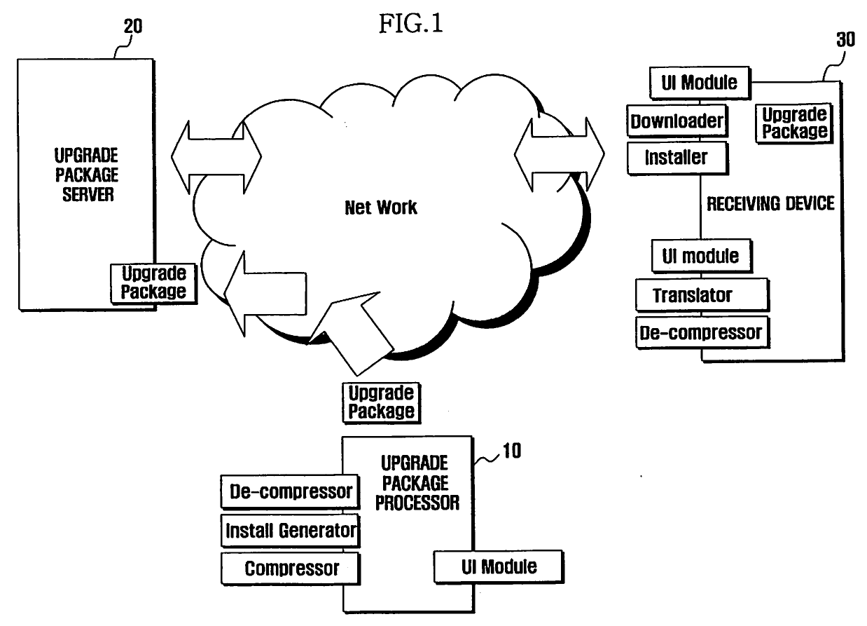

FIG. 1 is a diagram illustrating a program upgrade system according to an exemplary embodiment of the present invention.

Referring to FIG. 1, a program upgrade system includes an upgrade package processor 10, an upgrade package server 20, and a recipient device 30 that communicate with each other through a network.

If a new version (second version) of a program is introduced, the upgrade package processor 10 generates an upgrade package from the old version (first version) and the new version (second version) of the program and then transmits the upgrade package to the upgrade package server 20. The upgrade package processor 10 communicates with the upgrade package server 20 through a wireless channel established on the basis of a wireless communication standard such as Code Division Multiple Access (CDMA), Universal Mobile Telecommunication System (UMTS), Wireless Broadband (WiBro), Wireless Fidelity (Wifi), Worldwide Interoperability for Microwave Access (WiMAX), Bluetooth® (hereinafter “Bluetooth”), and Zigbee, or a wired communication standard such as Universal Serial Bus (USB) and Universal Asynchronous Receiver/Transmitter (UART). If an upgrade package is received from the upgrade package processor 10, the upgrade package server 30 transmits a notification message to a plurality of recipient devices 20 such that the recipient devices download the upgrade package. Also, the upgrade package server 20 and the recipient devices 30 communicate with each other through a wireless channel established on the basis of a wireless communication standard such as CDMA, UMTS, WiBro, Wifi, WiMAX, Bluetooth, and Zigbee, or a wired communication standard such as USB and UART. In this embodiment, the upgrade package processor 10 and the upgrade package server 20 are separately implemented. However, the upgrade package processor 10 and the upgrade package server can be integrated as a single apparatus.

If the upgrade package is successfully downloaded, the recipient device 30 stores the upgrade package in a memory unit for producing a second version of the program. The memory unit can be implemented with a first memory and a second memory. The first and second memories can be integrated in a single memory unit, or can be separated from each other. The first memory stores the first version of the program and the upgrade package, and the second memory loads the second version of the program produced from the first version of the program and the upgrade package. That is, the recipient device 30 stores the upgrade package downloaded from the upgrade package server 20 in the first memory as the information for creating the second version of the program. The second version of the program is generated by merging the first version of the program and the upgrade package and then loaded in the second memory, in response to an upgrade command. After the upgrade process, the recipient device 30 operates with the second version of the program loaded in the second memory.

An operation of the upgrade package processor 10 is described hereinafter.

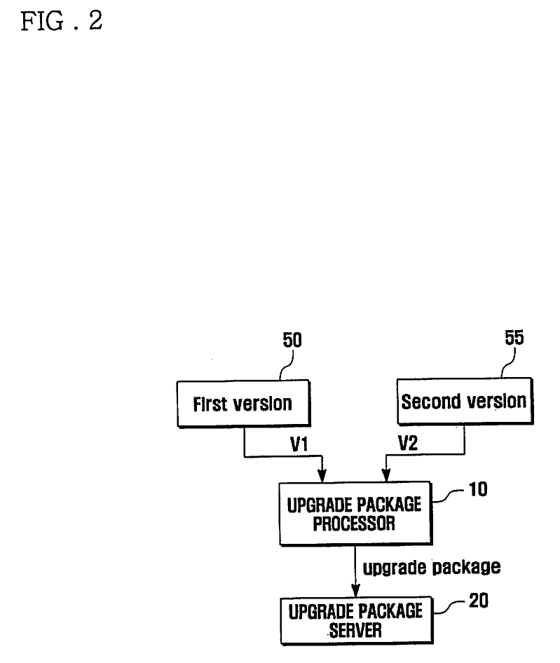

FIG. 2 is a block diagram illustrating an operation of the upgrade package processor 10 of the program upgrade system of FIG. 1.

Referring to FIG. 2, the upgrade package processor 10 receives the first version 50 and second version 55 of a target program input from outside. The second version 55 of the program can be an original version, and the first version 50 of the program can be one upgraded from the second version of the program. The upgrade package processor 10 generates the upgrade package from the first version 50 and the second version 55 of the program. The upgrade package processor 10 compares the first and second versions, 50 and 55, and produces the upgrade package on the basis of difference between the first and second versions, 50 and 55, and then transmits the upgrade package to the upgrade package server 20. The upgrade package includes upgrade data and install data. The upgrade data is generated in accordance with a difference between the first and second versions of the program, and the install data includes history information and map data. The history data is data to be merged with the second version, and the map data includes commands for copying, changing, and shifting according to a comparison result of the versions and index information of the commands. The upgrade package can include only the history data and map data. In this case, the modified data is included in the map data rather than in the upgrade data. The upgrade package can be transported to the upgrade package server 20 through a wired or wireless channel.

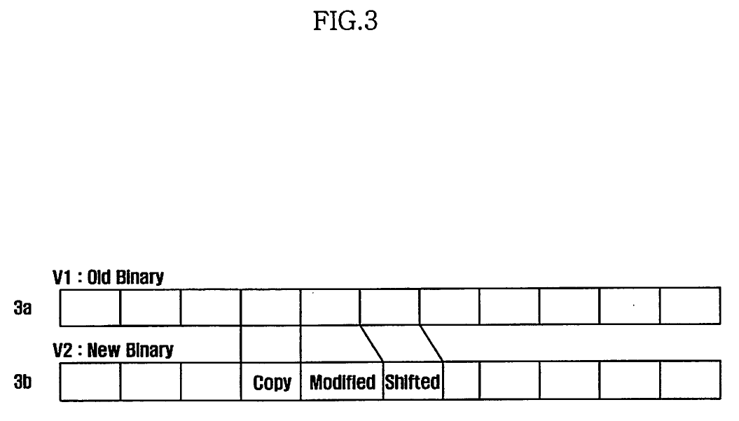

FIG. 3 is diagram illustrating a relationship between first and second versions for generating an upgrade package in the upgrade package processor 10 of FIG. 2.

Reference numeral 3a denotes a first version of the information, and reference numeral 3b denotes a second version of the information. The data of the second version of the information can be copied or modified from the data of the first version. According to variation of data amount, some parts of the data can be shifted.

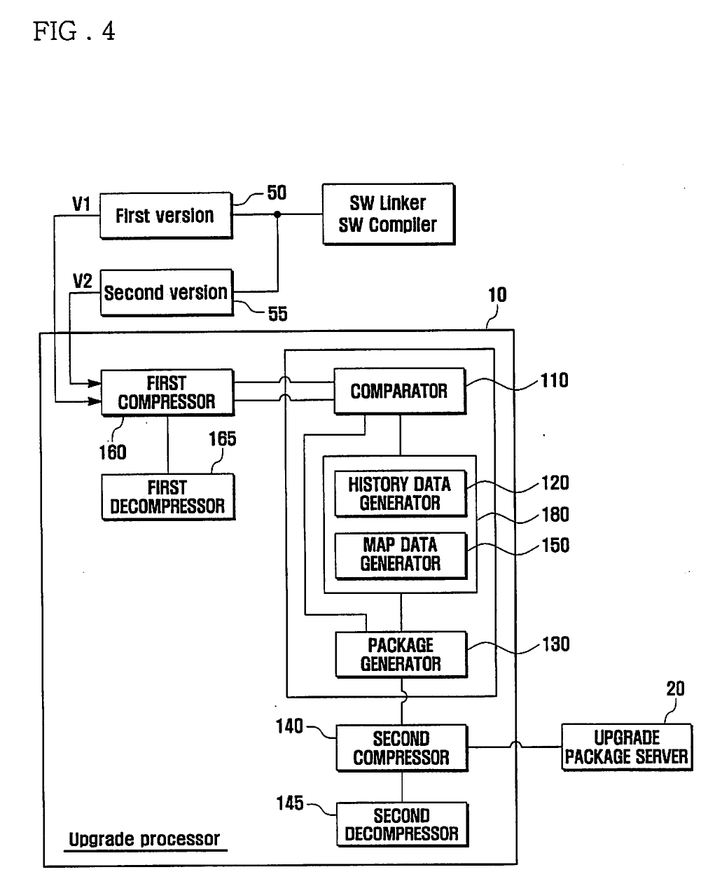

FIG. 4 is a block diagram illustrating a configuration of an upgrade package processor of a program upgrade system in accordance with an exemplary embodiment of the present invention. The upgrade package processor 10 compresses the first and second versions, 50 and 55, of the information, compares the two compressed versions, produces an upgrade data and install data including map data and history data with reference to a comparison result, generates an upgrade package by merging the install data and the upgrade data.

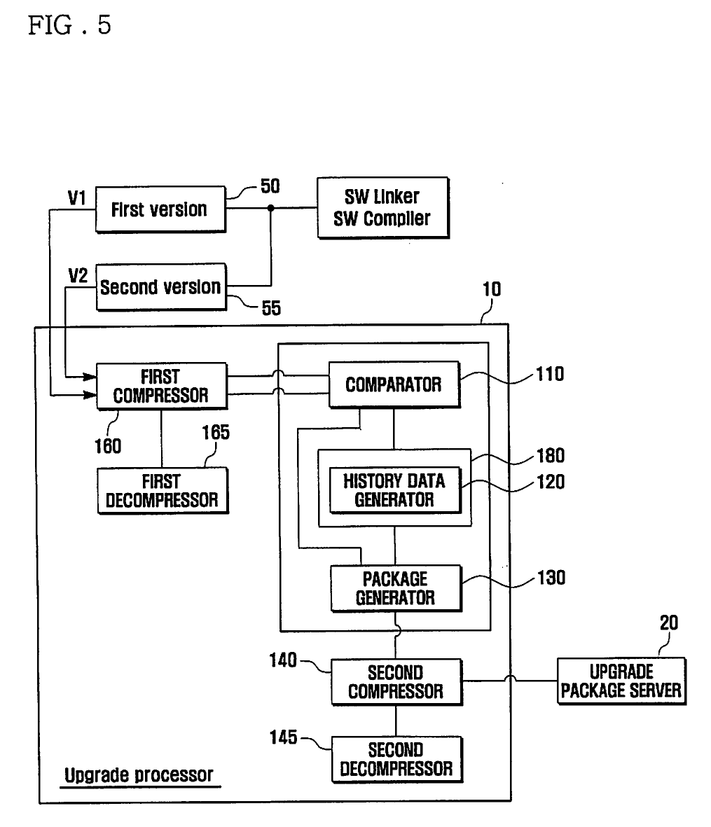

FIG. 5 is a block diagram illustrating a configuration of an upgrade package processor of a program upgrade system in accordance with another exemplary embodiment of the present invention. The upgrade package processor 10 compresses the first and second versions, 50 and 55, of the information, compares the compressed versions, produces upgrade data and install data with reference to the comparison result, and generates an upgrade package by merging the install data and the upgrade data. In this embodiment, the install data does not include map data.

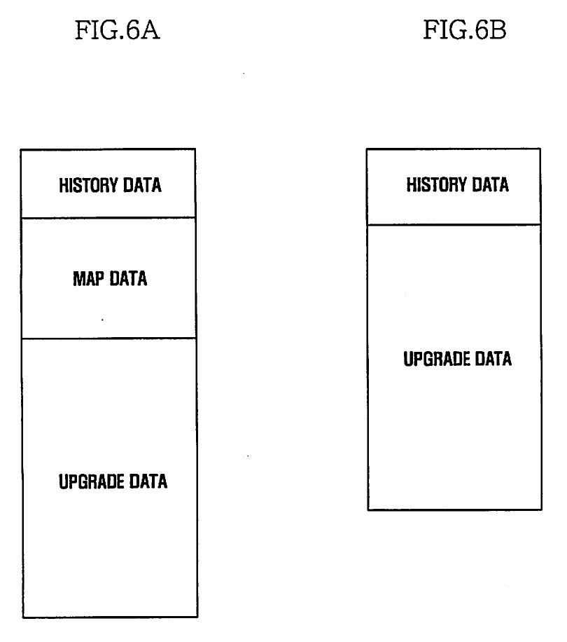

FIG. 6A is a diagram illustrating a data format of an upgrade package generated by the upgrade package processor of FIG. 4, and FIG. 6B is a diagram illustrating a data format of an upgrade package generated by the upgrade package processor of FIG. 5.

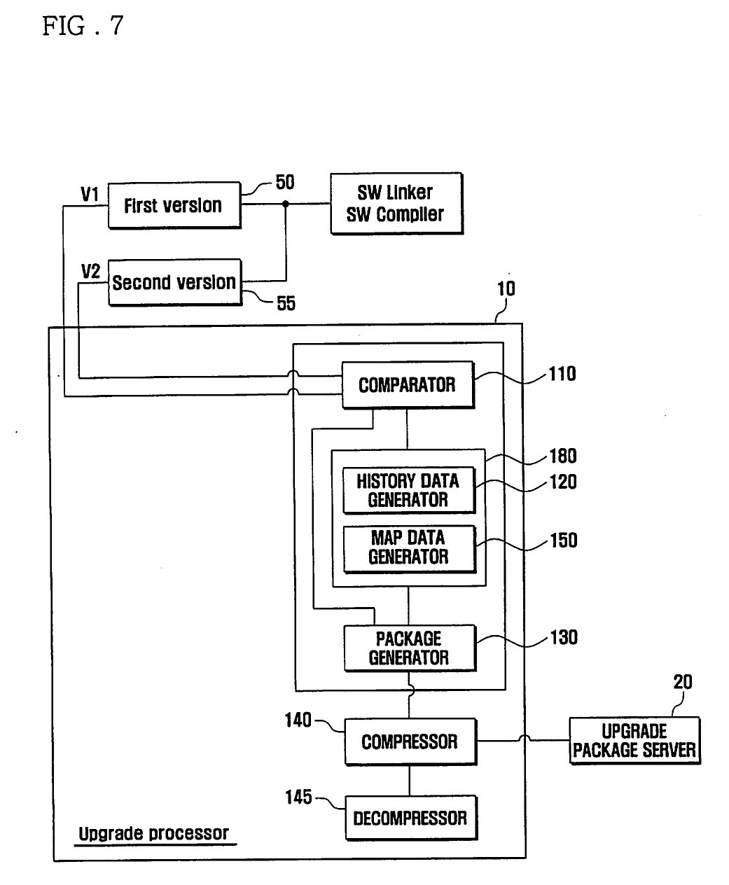

FIG. 7 is a block diagram illustrating a configuration of an upgrade package processor of a program upgrade system in accordance with another exemplary embodiment of the present invention. The upgrade package processor 10 compares raw data of the first and second versions, 50 and 55, produces an upgrade data and install data with reference to the comparison result, and generates an upgrade package by combining the upgrade data and the install data including map data and history data. In this case, the install data may not include map data.

In FIG. 4, the upgrade package processor 10 includes a first compressor 160, a first decompressor 165, a comparator 110, an install data generator 180 including a history data generator 120 and a map data generator 150, a package generator 130, a second compressor 140, and a second decompressor 145.

Referring to FIGS. 3, 4, 6A and 6B, the first and second versions 50 and 55 of a program are input after being compressed by the first compressor 160. However, the first and second versions 50 and 55 can be input in the form of raw data without compression (see FIG. 7). The first compressor 160 divides the data of the first and second versions of the program into a plurality of macroblocks (the term “block” is interchangeable used with “macroblock”) used in a predetermined size and compresses the data an a macroblock basis. The reason why the data is compressed is for enabling the comparator 110 to compare the data of the first and second version of the program on the macroblock basis. The comparator 110 compares the macroblocks of the first and second versions of the program on a block basis and determines if two blocks that have the same block index are identical with each other. If the two matching blocks of the first and second versions are not identical with each other, the comparator 110 searches for a block identical with that of the second version in a search range of the first version. If an identical block is found in the search range of the first version, the comparator informs the install data generator 180 of the comparison result with the block index of the block found.

As shown in FIG. 4, the install data generator 180 includes a history data generator 120 and a map data generator 150. However, the install data generator 180 also can be implemented only with the history data generator 120 (see FIG. 5).

In FIG. 4, the history data generator 120 includes a version number of the second version. For example, if the version number is 5, the first version is upgraded to the second version having the version number of 5. The map data generator 150 analyzes the block data output by the comparator 110 and generates the map data, which include commands for installing the upgrade package, on the basis of the analysis result. The commands include copy (C), modify (M), and shift (S) commands. The command C informs that the two blocks assigned the same block index are identical with each other, the command M informs that the block of the second version is modified from the block of the first version in size and data value, and the command S informs that the identical block is shifted to another position. The map data is formatted with the number of the blocks. The command S is provided with a shift value, and the command M is provided with the blocks of the second version as the upgrade data. Accordingly, the map data is formatted with C for indicating the identities of the blocks, M for indicating the modification of specific blocks, and S for indicating new locations of specific blocks. In the case that the second version is produced on the basis of the first version and the map data formatted with the commands, it is noted that the upgrade data is carried only when the map data includes the command M. If the map data include the commands C and S, the map data carries only the information on the block indexes of the first version to be used for upgrading the program to the second version. Accordingly, the upgrade data is likely to be the blocks indicated by block indexes carried by the command M. In the case of commands C and S, the information on the blocks and block indexes are provided as the install data.

As described above, the map data generator 150 analyzes the block indexes and comparison results output by the comparator 110 and generates the map data on the basis of the analysis result. The map data generator 150 generates the map data in accordance with the block indexes of the first and second version and the comparison result output by the comparator 110. If the compared blocks of the first and second versions are identical with each other, the map data generator 150 formats a command C followed by a string of block indexes of the corresponding blocks in the map data.

If the compared blocks of the first and second versions are not identical with each other, the map data generator 150 packs the corresponding block indexes with the command M or S. The command M can be interpreted as two types, i.e. an insertion command and a replacement command. The map data generator 150 continuously analyzes the comparison results and block indexes output by the comparator 110. If insertion blocks, which are required to be inserted into specific positions of the first version for producing the second version, are found during the analysis, the map data generator 150 formats a command M followed by a string of insertion blocks in the map data. If replacement blocks, which replaces specific blocks of the first version for producing the second version, are found during the analysis, the map data generator 150 performs an entropy coding on the difference between the blocks and incorporates the coded data in the map data. In the case that a specific block is replaced with another block having the same size, no shifting occurs for the second version.

That is, in the case of replacing a block by a new block having the same size without changing block index, the blocks following the replaced block are not shifted. In a case that the second version is obtained by deleting some blocks of the first version, the map data generator 150 formats a shift command followed by the block indexes of the blocks to be shifted in the map data. In this case, the blocks following the deleted blocks are shifted to the positions of the deleted blocks.

After formatting the shift command for inserting replaced blocks, the map data generator 150 analyzes the block indexes of the first and second versions output by the comparator 110 and generates the map data including block indexes of the second version, a number of blocks to be shifted, and numbers of shift blocks of the first and second versions.

During the above described operation, the upgrade package generator 100 may not generate the map data. This is the case that the recipient device is implemented to be able to generate the map data for installing the updated data using the information of the first version of the program. In this case, the map data generator 150 can be omitted.

The package generator 130 analyzes the compressed second version of the program output by the first compressor 160 and the map data output by the map data generator 250, and generates an upgrade package using the compressed second version and the map data. The package generator 130 analyzes the map data. If the map data contains only the C and S commands, the package generator 130 does not generate upgrade data. If the map data include the M command, the package generator 130 generates upgrade data with the compressed blocks of which block indexes are followed by the command M. That is, the package generator 130 generates the upgrade data when the map data includes the M command.

Next, the package generator 130 generates an upgrade package by merging the install data output by the install data generator 180 and the upgrade data. The install data can include only the history data or both the history and map data. That is, in the case where the install data generator 180 is implemented with the history data generator 120 and the map data generator 150 as shown in FIG. 4, the install data include the history data and the map data. The install data generator can be implemented only with the history data generator 120 (see FIG. 5). In this case, the install data includes only the history data.

Referring to FIG. 5, the install data generator 180 is implemented without the map data generator 150 unlike in FIG. 4. In this case, the package generator 130 generates the upgrade data including the block indexes of the first version mapped to the corresponding block indexes of the second version and information on the block data. At this time, the upgrade data is provided with commands of which formats are similar to those provided by the map data generator 150 of FIG. 4. That is, the upgrade data is formatted so as to include the copy command indicating a start block index and a number of blocks to be copied from the first version, the modify command indicating a start block index and a number of the blocks to be added or modified, and data of the blocks to be inserted for producing the second version, and the shift command indicating a start block index, a number of blocks to be shifted, and a block index of the first version matching the start block.

Next, the package generator 130 generates the upgrade package by merging the upgrade data and the history data and transports the upgrade package to the upgrade package server 20. The upgrade package generated by the upgrade package generator 130 can be compressed by the second compressor 140 before transportation. In the case that the upgrade package is produced without generation of map data, the upgrade package generation speed can be improved.

The upgrade package can be composed of history data, map data, and upgrade data, or composed of history data and upgrade data. The upgrade package processor 100 of FIG. 4 generates the upgrade package shown in FIG. 6A which is composed of the history, map data, and upgrade data. The upgrade package processor 100 of FIG. 5 generates the upgrade package shown in FIG. 6B which is composed of a history data and upgrade data.

The upgrade package generated by the package generator 130 is compressed by the second compressor 140 and then transported to the upgrade package server 20. Since the upgrade package is compressed by the first compressor 160, the second compressor 140 can be omitted. The second compressor 140 is enabled for increasing the transmission efficiency. In the case that the first and second versions of the program are compressed by the first compressor 160, the first decompressor 165 decompress the compressed first and second versions for testing if the first and second versions are successfully compressed. If an error is detected, the first controller 160 performs the compression again.

In FIGS. 4 and 5, the upgrade package processor 10 compresses the first and second versions and generates the upgrade package on the basis of the comparison results on the compressed data of the first and second versions.

However, it is possible for the comparator 110 to compare the first and second versions of the program in the form of raw data. The upgrade package processor 10 depicted in FIG. 7 is implemented without the first compressor such that the first and second versions are compared in the form of raw data. The structure and functions of the upgrade package processor 10 of FIG. 7 is identical with that of the upgrade package processor of FIG. 4 except for the first compressor. In FIG. 7, the upgrade package processor 10 includes the install data generator composed of the history data generator 120 and the map data generator 130 for generating the history data and map data, respectively. However, the install data generator can be implemented only with the history data generator 120.

As described above, the upgrade package processor 10 compares the second version to the first version and generates an upgrade package on the basis of the comparison result.

If the second version has new data blocks that do not exist in the first version or some data blocks of the first version do not exist in the second version, the blocks following the newly added blocks or deleted blocks are shifted in a right or a left direction. The blocks of the second version modified from those of the first version are entropy-coded. The blocks following the modified blocks of the second version are shifted as many as the number of the inserted or deleted blocks. After comparing the blocks of the first and second blocks, the upgrade package processor 10 generates map data composed of C, M, and S command strings. The command strings can be carried by the upgrade data when the map data is not generated in the upgrade package processor 10. Next, the upgrade package processor 10 produces an upgrade package by packing the map data, history data, and upgrade data and transports the upgrade package to the upgrade package server 20. The upgrade package can be transported to the upgrade package server 20 through a wired or wireless channel.

If an upgrade package is received from the upgrade package processor 10, the upgrade package server 20 notifies the recipient devices 30 of an issuance of a new upgrade package such that the recipients 20 can download the upgrade package from the upgrade package server 20. The upgrade package server may include a notification server for notifying the issuance of new upgrade package.

If an upgrade notification message is received from the upgrade package server 20, the recipient device 30 triggers a download session by responding to the upgrade notification message.

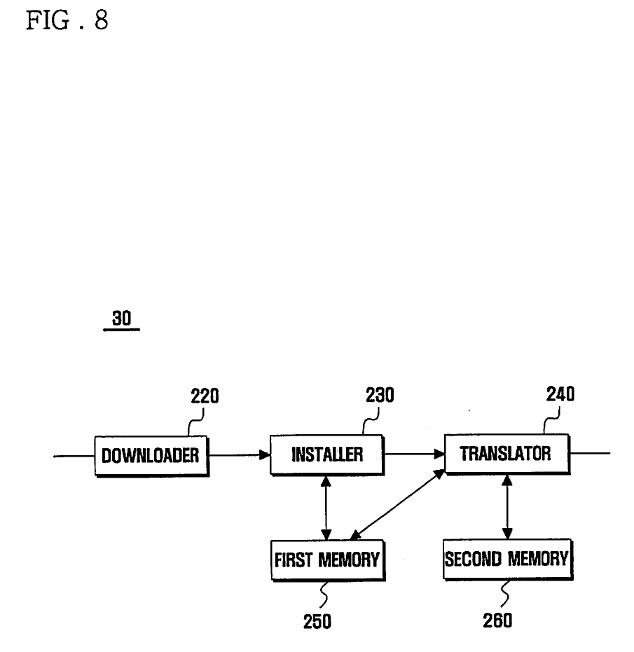

FIG. 8 is a block diagram illustrating a configuration of a recipient device of a program upgrade system according to an exemplary embodiment of the present invention.

Referring to FIG. 8, the recipient device 30 includes a downloader 220, an installer 230, a translator 240, a first memory 250, and a second memory 260.

The downloader 220 receives the upgrade package downloaded from the upgrade package server (not shown), the installer 230 extracts install data and upgrade data and stores the extracted install data and upgrade data into the first memory 250. The install data is composed of history data and map data. However, the install data may include only the history data. In the case that the install data has no map data, block mapping information can be contained in the upgrade data. If the install data having no map data is received, the installer 230 performs a comparison analysis on the first version and the upgrade data and generates map data or not depending on the analysis result. In the case where no map data is generated by the installer 230, the translator 240 can merge the upgrade package and the first version of the program using the mapping information contained in the upgrade data. The installer 230 stores the history data, map data, and upgrade data within a region of the first memory 250 prepared for the upgrade package. The first memory 250 can store the first version of the program and at least one upgrade package for updating the first version to the second version of the program. A number of the upgrade packages N that can be stored in the first memory 250 can be preset. In this embodiment, N is set to 6.

If an upgrade package for a new version of the program is downloaded, the recipient device 30 outputs an alert for notifying the user that a program upgrade is prepared.

Upon an upgrade start command being detected or the recipient device being rebooted, the translator 240 of the recipient device 30 reads out the data of the first version of the program and the upgrade package for the second version from the first memory 250 and merges the data of the first version and the upgrade package so as to produce the second version of the program. The second version of the program is loaded on the second memory 260. At this time, the translator 240 analyzes the install data of the upgrade package to check a version number and a target version (in this embodiment, the first version) to be upgraded. Also, the translator 240 analyses the map data and upgrades the data of the blocks of the target version with corresponding upgrade data with reference to the map data. After the program is upgraded to the second version, the second version of the program is loaded on the second memory 260 such that the recipient device 30 operates with the second version of the program.

As described above, the first memory 250 stores the first version of the program and at least one upgrade package for upgrading the first version to a second version. The upgrade package includes install data (history and/or map data) and upgrade data. The install data can be composed of only the history data and upgrade data. The install data are composed of the history data for updating the first version with the update data and the map data having information on data mapping.

The map data provides information on a relationship between the two versions with 3 types of commands i.e. copy, modify, and shift. The map data is used for quick address calculation for updating the data of the first version to the data of the second version. With reference to the data of the first version stored in the first memory 250 and the map data, the second version of the program can be quickly generated and loaded on the second memory 260.

The install data of the upgrade package can be produced with or without the map data at the upgrade package processor (not shown). Accordingly the upgrade package downloaded from the upgrade package server may or may not include the map data. In the case that the upgrade package has no map data, the installer 230 can produce the map data by comparing the data of the first version stored in the first memory 250 and the upgrade package and analyzing the comparison result for mapping the upgrade data contained in the upgrade package to the data of the first version.

Although the program is typically upgraded using the latest upgrade package, the first version can be upgraded with an upgrade package for another version of the program. This is possible because the recipient device 30 allows for the storing of up to N upgrade packages (in this embodiment, N=6). Accordingly, if an upgrade to the second version fails with an upgrade package, another upgrade package can be selected from the first memory 250. The recipient device 30 displays an update package list such that the user can select one of the update package from the list.

The first memory 250 can be implemented with several storage parts for independently storing upgrade packages (in this embodiment, 6 upgrade packages can be stored). Accordingly, although a latest upgrade package is downloaded from the upgrade package server, previously downloaded upgrade packages are not deleted. The upgrade records are stored in the form of an upgrade history while maintaining the data of the first version of the program. Since the information on the first and second versions is maintained with the upgrade history, the upgrade operation can be performed with a high fault tolerance. For example, when the last upgrade package fails to upgrade the program, another upgrade package can be selected by the user. Even in the worst case that all the upgrade packages fail to upgrade the program, the original version of the program can be loaded.

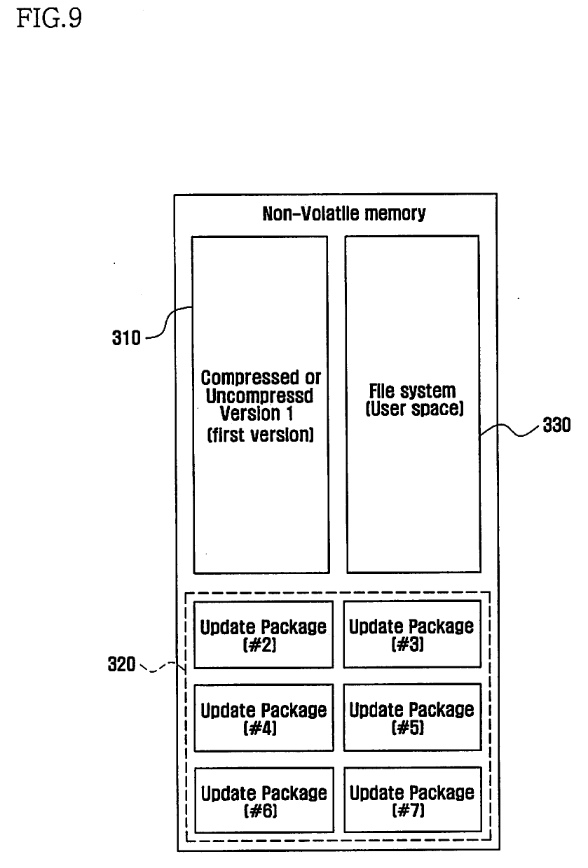

FIG. 9 is a block diagram illustrating a configuration of a first memory of a recipient device of FIG. 8. Referring to FIG. 9, the first memory includes a first storage region 310, a second storage region 320, and a third storage region 330.

The first storage region 310 stores the first version of the program in the form or raw data or compressed data. The second storage region 320 stores at least one upgrade package for generating a new version of the program. Each upgrade package includes the upgrade data and the install data. The upgrade data may include commands with block indexes for updating the data of an old version, or data to be added for the new version. Accordingly, the size of the second storage region 320 is determined by a number of the upgrade packages stored therein. For example, each storage region for storing an upgrade package can be set to 300 Kbyte. In this case the total size of the second region becomes 1.8 Mbyte. The third storage region 330 is a user space for storing user data with a file system.

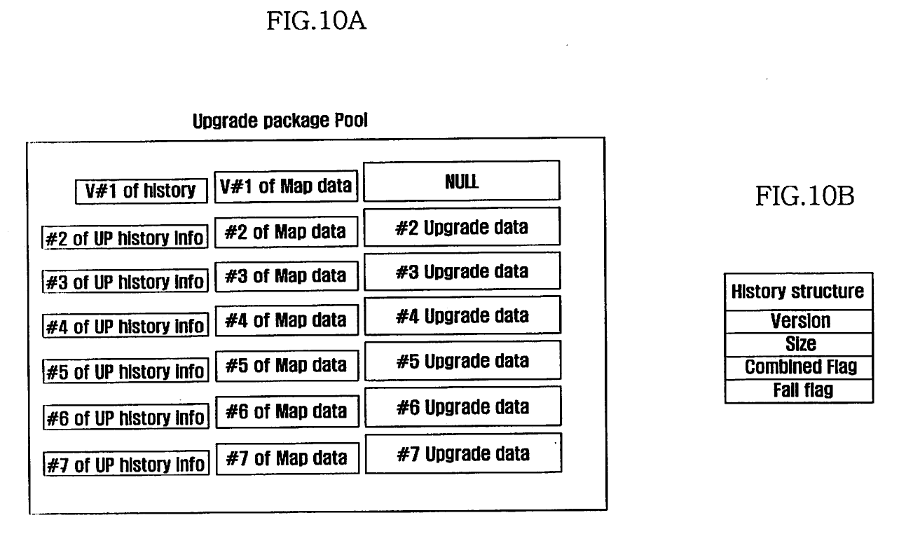

FIG. 10A is a diagram illustrating a structure of the second storage region of the first memory 250 of FIG. 9, and FIG. 10B is a diagram illustrating a data format of the history data of each upgrade package stored in the second storage region of FIG. 10A.

Referring to FIG. 10A, the second storage region 320 is provided with a predetermined number of storage parts for storing the upgrade packages (in this embodiment, 6 upgrade packages). Each storage part is structured so as to independently store the history data, map data, and upgrade data constituting the upgrade package. Typically, the upgrade package includes the install data and the upgrade data, and the install data is composed of the history data or the history and map data (see FIGS. 4 and 5). The second storage region 320 can be configured to separately store the history data and the map data. The history data is stored for maintaining a link to the first version stored within the first storage region 310. The map data and upgrade data of the first version may not be stored or exists as null data. FIG. 10a shows an example of the upgrade package composed of the history data, map data, and upgrade data.

Referring to FIG. 10B, the history data includes a version field, a size field, a combined flag field, and a fail flag field. Here, the version field contains a version number of the upgrade package (one of #2 to #7 in FIG. 10A), the size field contains a size value of the history data, the combined flag field contains a version number of a target version to be upgraded (in this example, the version number #1 of the first version), and the fail flag field contains information on the occurrence of loading failure. The version number #1 of the first version can be contained in the version field and linked to the combined flag field. For example, if a version field and combined flag field of the history data of an upgrade package, respectively, contain #5 and V#1, the recipient device 30 upgrades the first version of #1 by merging the second version of #5 and the first version of #1. The downloaded upgrade package is stored in the second storage region 320 of the first memory 310 shown as shown in FIG. 9 in the structure of FIGS. 10A and 10B. When an upgrade package stored in the second storage region 320 is requested, the requested package is merged with the first version stored in the first storage region 310 such that the first version is upgraded to the second version.

An upgrade package composed of the map data, history data, and upgrade data is described hereinafter.

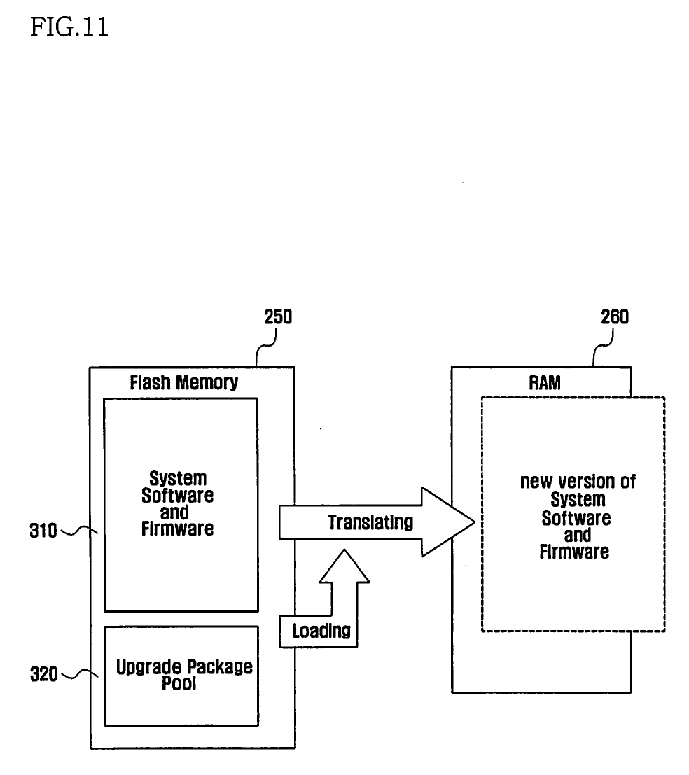

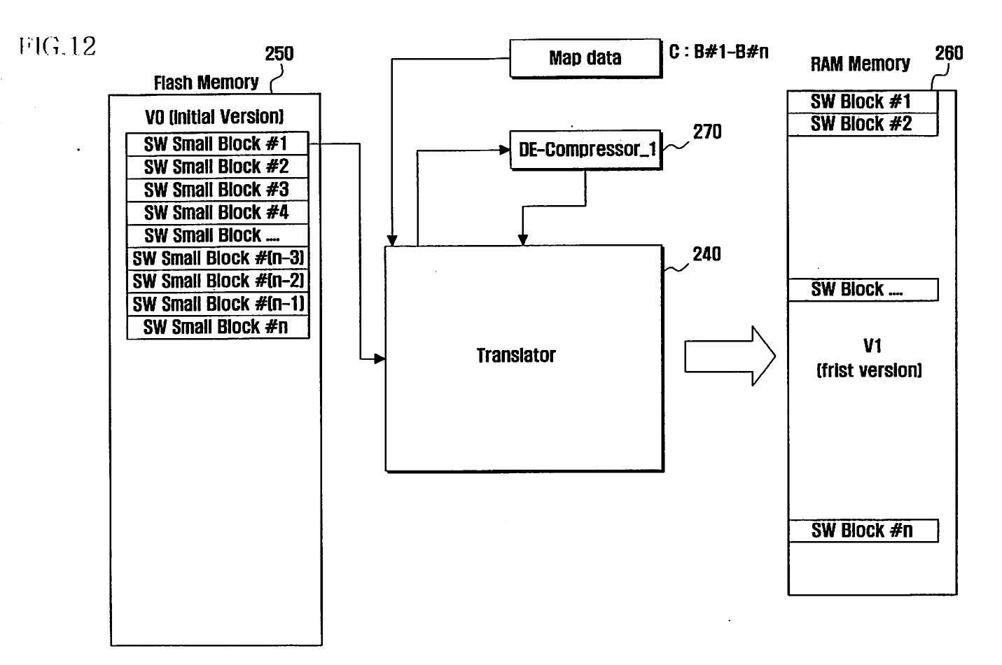

FIG. 11 is a block diagram illustrating a storage structure for an upgrade operation of a program upgrade system according to an exemplary embodiment of the present invention. As shown in FIG. 11, the first memory is a non-volatile memory such as a flash memory, and the second memory is a volatile memory such as a random access memory (RAM).

Referring to FIG. 11, if an upgrade command is input, a loader (not shown) loads an upgrade package of the requested version from the second storage region 320 of the first memory 250, and the translator 240 generates a second version of the program by merging the loaded upgrade package and the first version of the program stored in the first storage region 310 and then loads the second version in the second memory 260. The upgrade command is generated in response to a user request. That is, the recipient device 30 outputs an alert for notifying the user of an issuance of an upgrade package when an upgrade package is downloaded or there exists a downloaded package which is not applied yet, such that the user can trigger to upgrade the target program. If the upgrade command is input by the user in response to the upgrade alert, the recipient device 30 performs an upgrade process as described above and loads the upgraded version of the program on the second memory 260. Accordingly, the recipient device 30 operates with the second version afterward.

The upgrade process can be performed after the recipient device 30 is initialized. As shown in FIG. 9, the first version and upgrade packages of the program are separately stored in the first memory 250, and the program upgrade is performed by merging the first version and one of the upgrade packages such that the second version of the program is generated and loaded in the second memory 260.

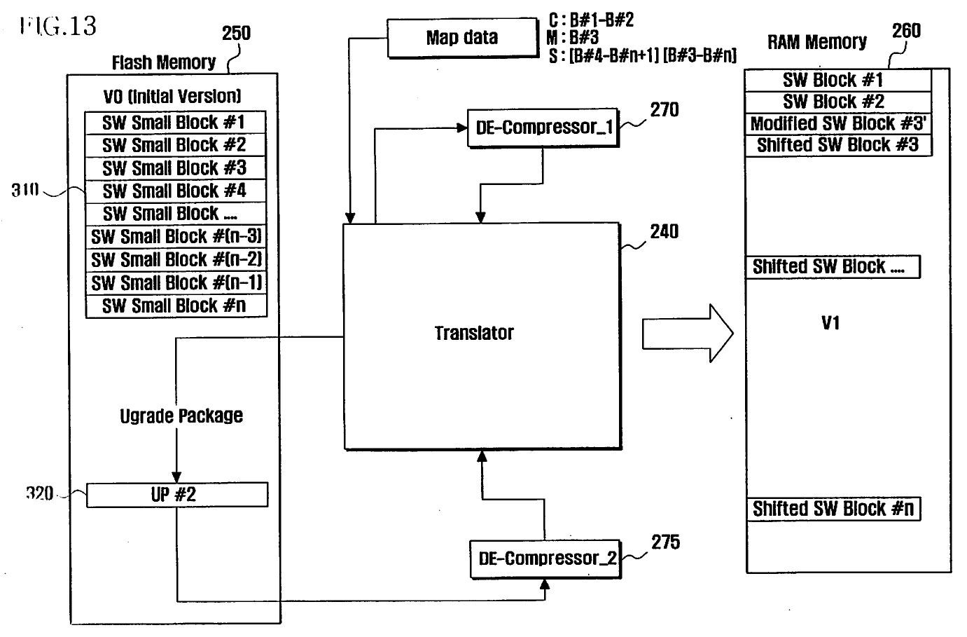

FIG. 12 is a block diagram illustrating a storage structure for an upgrade operation of a program upgrade system according to another exemplary embodiment of the present invention. In this embodiment, the first memory 250 stores no upgrade package for the second version.

Referring to FIG. 12, the first memory 250 stores the first version of the program. Here, the first version can be an initial version of the program. The first version of the program is composed of n blocks B#1 to B#n. The install data of the second version includes history data and map data. The history data may include merging information of the first version. The map data can be structured in the form of C:B#1-B#n.

If an upgrade command is input, the translator 240 analyzes the install data. In the case of FIG. 12, the map data of the install data includes the copy command string C:B#1-B#n for copying all the blocks, the translator 240 copies all the data blocks of the first version from the first memory 250 and loads the blocks on the second memory 260. Accordingly, the recipient device 30 is operated with the first version loaded on the second memory 260. The first version can be stored in the first memory 250 in a compressed state. In this case, the translator 240 decompresses the compressed first version using the decompressor 270 and then loads the decompressed first version on the second memory 260. Also, when an upgrade package compressed by the second compressor 140 of the upgrade package processor 10 is downloaded, the translator 240 performs the translation after the compressed upgrade package is decompressed by the decompressor 270 before loading in the second memory 260.

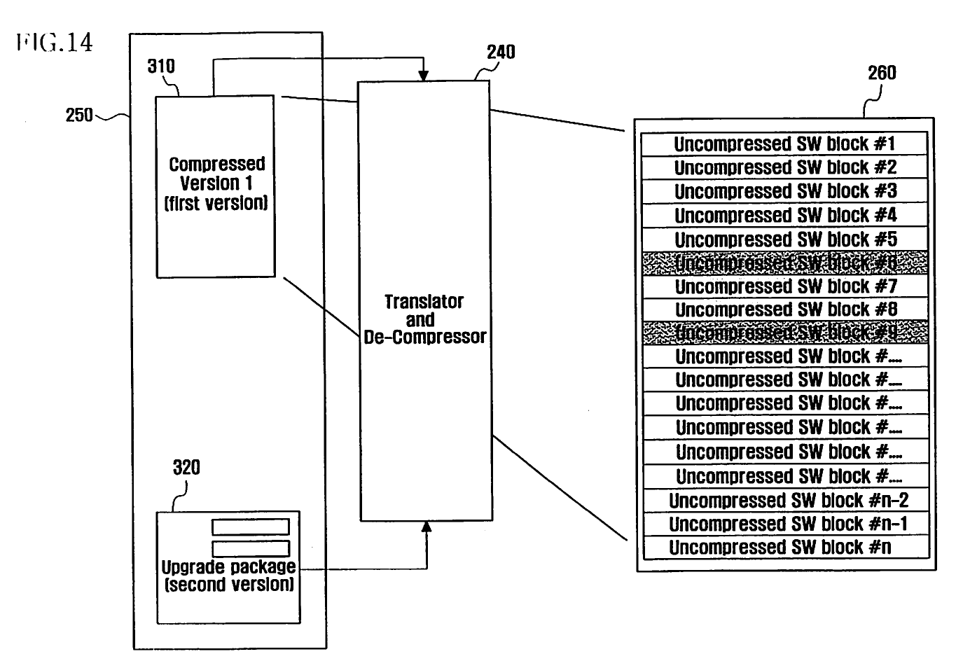

FIG. 13 is a block diagram illustrating a storage structure for an upgrade operation of a program upgrade system according to another exemplary embodiment of the present invention.

Referring to FIG. 13, the first memory 250 stores the first version of the program in the first storage region 310 and an upgrade package in the second storage region 320. The first version can be an initial version of the program or a specific version of the program designated as a reference version. The upgrade package includes the upgrade data and the install data. The install data includes the history data and the map data having a version number of the second version and a version number of the old version (in this embodiment, the first version) to be upgraded to the second version. In FIG. 13, it is assumed that the first version is composed of n blocks B#1 to B#n. Also, it is assumed that he history data is provided with a combined flag set to #1, and the map data are composed of command strings C:B#1-B#2, M:B#3, and S:[B#4-B#n+1][B#3-B#n]. In this case the map data give information that the blocks B#1 and B#2 of the second version are duplicates of the blocks B#1 and B#2 of the first version, the block B#3 contains modified data, and the blocks B#4 to B#n+1 of the second version are shifted and identical with the blocks B#3 to B#n of the first version.

If an upgrade command is input, the translator 240 analyzes the install data and upgrades the first version of the program stored in the first memory 250 using the upgrade data UP#2 on the basis of the analysis result such that the upgraded version of the program is loaded in the second memory 260. At this time, the translator 240 copies the blocks B#1 and B#2 of the first version stored in the first memory 250, modifies the data of the block B#3 into the data of the UP#2, shifts the blocks following the block B#3 of the first version so as to be the blocks B#4 to B#n+1 of the second version, and loads the second version in the second memory 260. In this case, the upgraded version loaded in the second memory has the data of UP#2 updated from the block B#3 and the blocks B#4 to B#n+1 shifted by 1 block. After the second version of the program is loaded in the second memory 260, the recipient device 30 operates with the second version. The first version and the upgrade packages downloaded from the upgrade package server 20 are stored after being compressed. The upgrade package is compressed by the second compressor 140 of the upgrade package processor 10.

In the case where the first version and the upgrade packages are stored in the compressed formats, the translator 240 decompresses the compressed first version and the upgrade packaged using the decompressor 270. In the case where the first and second versions are compared in the compressed states (when the first and second versions are compressed by the first compressor 160 of the upgrade package processor 10), the blocks are input to the translator 240 in the compressed data formats. In this case, the translator 240 decompresses the compressed data of the first version and the upgrade package using the decompressor 275 and loads the decompressed data on the second memory 260.

FIG. 14 is a block diagram illustrating a storage structure for an upgrade operation of the recipient device of the program upgrade system according to an exemplary embodiment of the present invention.

Referring to FIG. 14, the first memory 250 stores the first version of the program and upgrade packages for the second version. The translator 240 merges an upgrade package and the first version in response to an upgrade command such that the second version is generated and loaded in the second memory 260. After the second version of the program is loaded in the second memory 260, the recipient device is operated by the second version of the program. The upgrade process can be iteratively performed when the recipient device is initialized or an upgrade command is input.

As described above, the program upgrade method according to an embodiment of the present invention downloads an upgrade package through a predetermined communication standard channel, stores the downloaded upgrade package, performs upgrade of the program using the stored upgrade package, loads the upgraded program, and operates the recipient device under the control of the upgraded program.

The program upgrade method of the present invention can be composed of an upgrade package generation procedure, a downloaded install data processing procedure, a downloaded upgrade package management procedure, and an upgrade execution procedure.

In the upgrade package generation procedure, the first and second versions of the program are input to the upgrade package processor. The first and second versions can be input in a raw or in a compressed state. Next, the first and second versions are compared such that differences between the two versions are checked. On the basis of the differences, install data including map data for merging the upgrade package with the first version installed in the recipient device are generated. The install data is packed into an upgrade package together with upgrade data.

In the downloaded install data processing procedure, the upgrade package transmitted to the upgrade package server is downloaded to a recipient device. The recipient device can obtain the install data contained in the upgrade package by comparing the upgrade package with a reference version (here, the first version), and the install data facilitate address calculation. That is, when merging the first version stored in the first memory and the upgrade package in the second memory, the data of the first version and upgrade package can be quickly processed on a block by-block-basis, using the install data.

In the upgrade package management procedure, the install data are used for fast address calculation with reference to the map data that are obtained by comparing the upgrade package and the first version and used for facilitating merging of the first version and the upgrade package in the second memory. In a case that the map data are not contained in the upgrade package, the recipient device can obtain the map data by comparing the first version stored in the first memory and the downloaded upgrade package. The install data also includes history data of the upgrade package. The history data contains the versions of the upgrade packages and the target program to be upgraded. In this embodiment, 6 upgrade packages can be stored in the first memory. When a merging operation fails with a specific upgrade package, the recipient device allows the user to select another upgrade package by displaying an upgrade package list.

In the upgrade execution procedure, the upgrade packages are stored in the corresponding storage parts of the first memory. The second region of the first memory is provided with a plurality of storage parts. When a new upgrade package is downloaded, the previously downloaded upgrade package is not erased. Accordingly, when a specific upgrade package is not loaded, the recipient device allows the user to select another upgrade package by displaying an upgrade package list. Even in the worst case that all upgrade packages are not loaded, the first version of the program can be loaded.

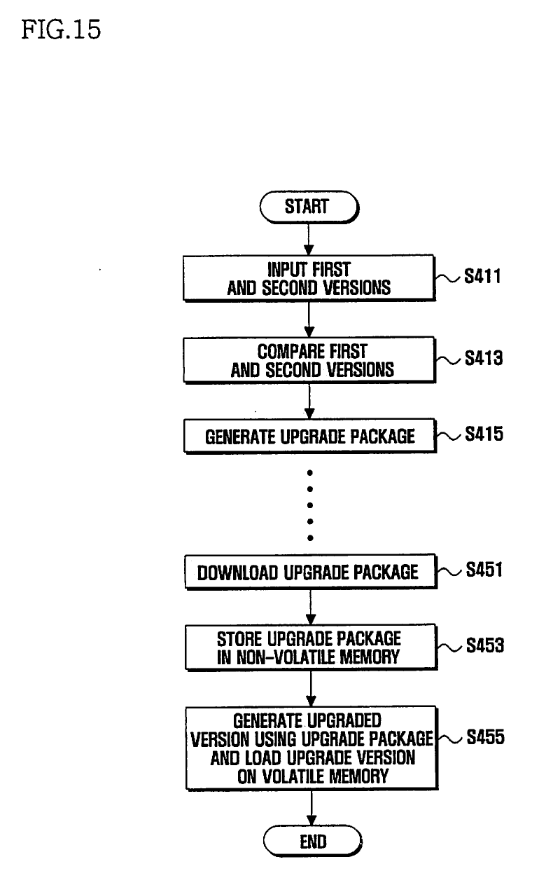

FIG. 15 is a flowchart illustrating a program upgrade method according to an exemplary embodiment of the present invention. The steps of the program upgrade method are depicted in relation with the operations of the upgrade package processor 10 and the recipient device 30 of the program upgrade system of FIG. 1.

Referring to FIG. 15, the upgrade package processor 10 receives the first and second versions of a program at step S411. An upgrade package is generated, when a new version of the program is introduced, by comparing the old version, i.e. the first version, and the new version, i.e. the second version. The upgrade package is composed of upgrade data and install data. The first version can be an original version or a reference version that is programmed to be merged with upgraded packages. The upgrade package is an information package for upgrading the first version of the program installed in the recipient device to the second version. The recipient device can store at least one upgrade package. If the first and second versions of the program are received, the upgrade package processor 10 analyses differences between the first and second versions at step S413, and generates an upgrade package on the basis of the analysis result at step S415. The upgrade package can be composed of upgrade data and install data containing information for combining the upgrade data with the first version. The install data includes history data providing a history of the second version and map data providing information for mapping the blocks of the first and second versions of the program. The upgrade package can be produced without map data. In this case, the recipient device generates the map data during the program upgrade process.

If the upgrade package is successfully generated, the upgrade package processor 10 transmits the upgrade package to the upgrade package server 20. Upon receiving the upgrade package, the upgrade package server 20 transmits an upgrade notification message to the recipient device 30. If an upgrade notification message is received, the recipient device 20 starts downloading the upgrade package in response to a user command. The upgrade package download can be performed on the basis of a communication standard technology supported by the recipient device 30. The communication standard technology can be one of CDMA, UMTS, GSM, WiBro, Wifi, WiMAX, Bluetooth, UWB, Zigbee, and USB.

If the upgrade package download is started, the recipient device 30 receives the upgrade package at step S451 and stores the downloaded upgrade package into the first memory 250. The first memory 250 is provided with the first storage region 310 for storing the first version of the program and a second storage region 320 for storing the upgrade packages. The second storage region 320 can be structured in the form of multiple storage parts for storing corresponding upgrade packages. In this embodiment, the second storage region 320 has 6 storage parts. Each storage part can separately store the history, map data, and upgrade data. In the case where the map data is not contained in the install data of the downloaded upgrade package, the installer of the recipient device 30 generates the map data with reference to the upgrade package and the first version of the program and stores the map data in the first memory 250. After the upgrade package is stored in the first memory 250, the recipient device 30 upgrades, in response to a user command, the program to the second version by merging the upgrade package and the first version and then loads the second version of the program on the second memory 260 in step S455. Accordingly, the recipient device 20 operates with the second version of the program afterward. The second memory 260 can be a working memory such as a volatile memory. In such a manner, the recipient device 30 generates the second version of the program by merging the first version stored in the first memory 250 and the recently downloaded upgrade package in a system initialization process, and loads the second version in the second memory 260 for controlling operations of the recipient device 30. When the program upgrade fails with a specific upgrade package, the recipient device 30 can automatically try to upgrade the program with another upgrade package stored in the first memory 250. Also, the recipient device 30 allows the user to select an upgrade package listed on an upgrade package list such that the first version is upgraded with selected upgrade package.

An upgrade package generation procedure is described hereinafter in more detail.

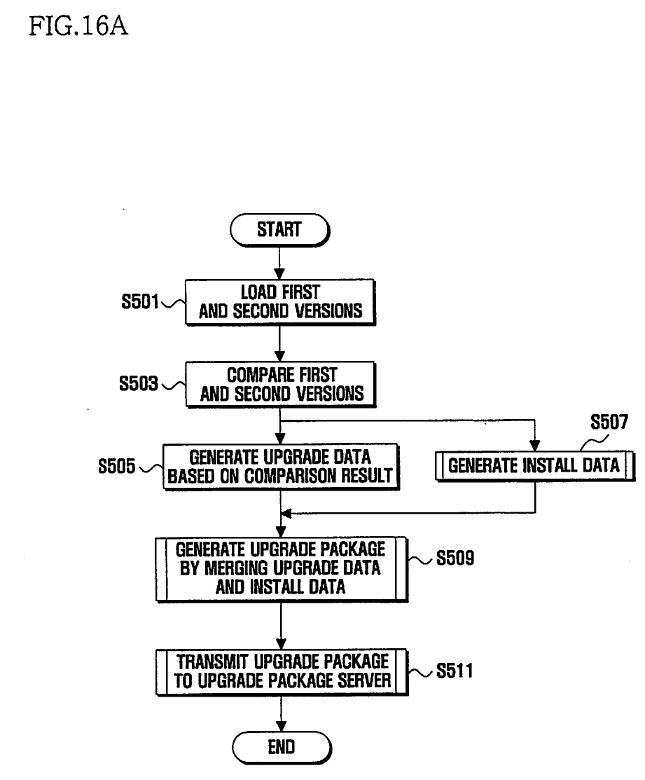

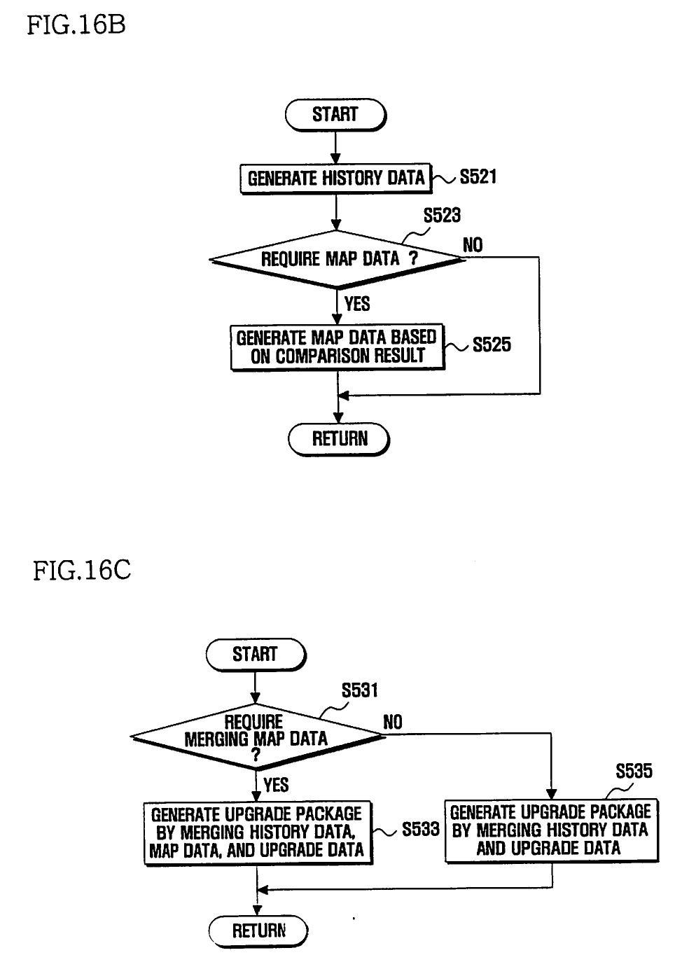

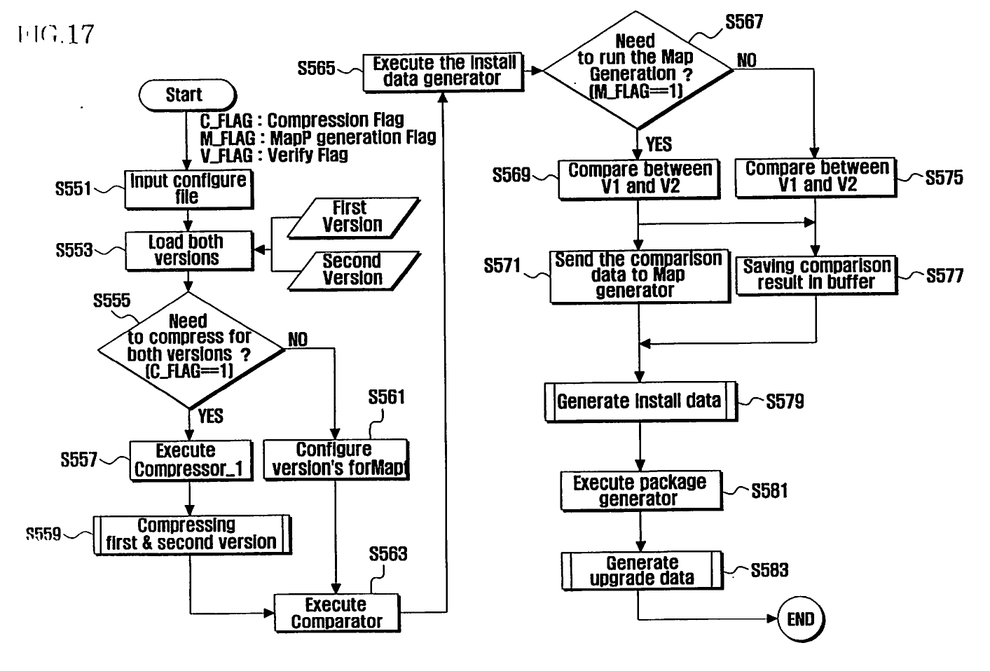

FIGS. 16A to 16C are flowcharts illustrating an upgrade package generation procedure of a program upgrade method according to an exemplary embodiment of the present invention.

Referring to FIG. 16A, the upgrade package processor 10 receives the first and second versions of the program at step S501, and compares the two versions with each other to check for differences between the two versions in step S503. After checking for the differences between the first and second versions, the upgrade package processor 10 generates comparison analysis data. Next, the upgrade package processor 10 generates upgrade data in step S505 and install data on the basis of the comparison analysis in step S507. The upgrade package processor 10 can be implemented with a package generator 130 and an install data generator 180. In this case, the upgrade data and install data can be generated in parallel processes. The package generator 130 also can be implemented to generate the upgrade data and the install data in series. In this case, the upgrade data can be generated before or after the generation of the install data.

The install data provides information for merging the upgrade package with the first version of the program in the form of the history data and map data. The history data contains the version information of the first and second versions of the program and the size of the versions of the program. The map data provides information for mapping blocks of the first and second versions of the program. The map data can be generated at the upgrade package processor 10 or at the recipient device 30. Accordingly, the map data may not be packed in the upgrade package.

FIG. 16B is a flowchart illustrating the install data generation procedure of step S507 of FIG. 16A, and FIG. 16C is a flowchart illustrating upgrade package generation procedure of step S509 of FIG. 16A.

In the install data generation procedure of FIG. 16b, the map data may or may not be generated. Also, in the upgrade package generation procedure of FIG. 16C, the map data may or may not be merged or not. Referring to FIG. 16B, the upgrade package processor 10 generates the history data in step S521 and determines whether map data is required for the upgrade package in step S523. If the map data is required, the upgrade package processor 10 generates the map data with reference to the comparison analysis in step S525. Referring to FIG. 16C, the upgrade package processor 10 determines whether to pack the map data in the upgrade package in step S531. If it is determined to pack the map data in the upgrade package, the upgrade package processor 10 generates the upgrade package with the map data in step S533, and otherwise, the upgrade package processor 10 generates the upgrade package without map data in step S535.

At step S501 of FIG. 16A, the first and second versions of the program can be input in a state of raw data or compressed data. For example, the first and second versions can be compressed by the first compressor 160. Also, the upgrade package generated at step S509 can be compressed before being transmitted to the upgrade package server 20. For example, the upgrade package can be compressed by the second compressor 140 of the upgrade package processor 10. By compressing the first and second versions, the data processing time taken for comparing the first and second versions can be reduced. Also, the compression of the upgrade package can reduce the time required for transmitting the upgrade package. When the data compression is applied, the compressed data is decompressed for a reliability test. Only when the compressed data pass the test, can the next process be performed.

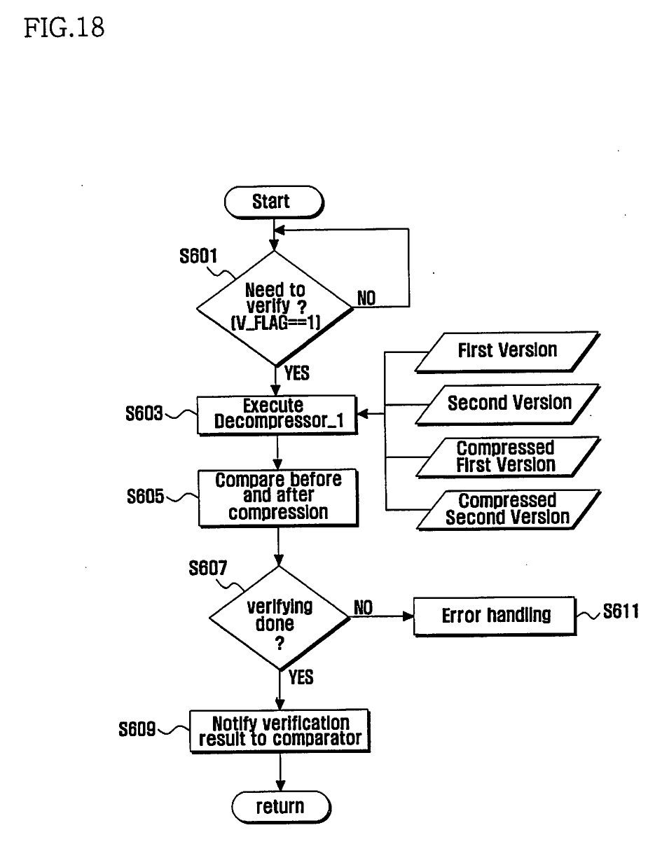

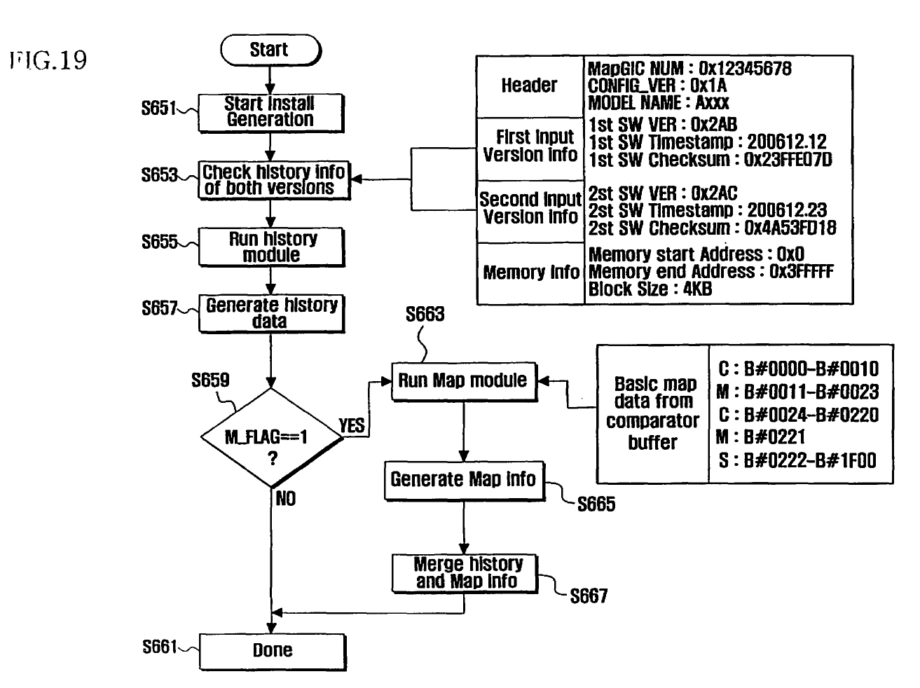

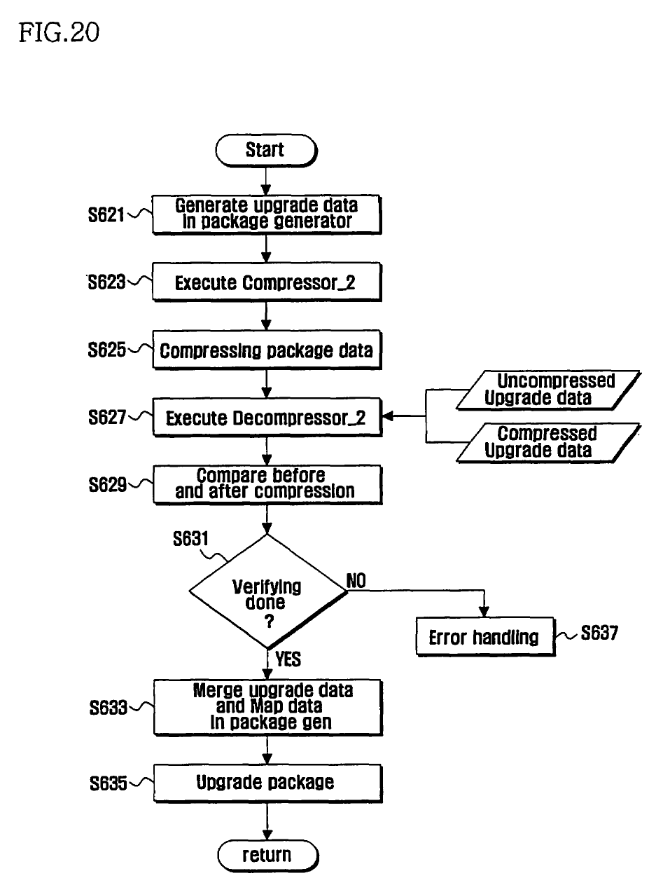

FIG. 17 is a flowchart illustrating an upgrade package generation procedure of a program upgrade method according to an exemplary embodiment of the present invention, FIG. 18 is a flowchart illustrating a compression reliability test procedure of FIG. 17, FIG. 19 is a flowchart illustrating an install data generation procedure of FIG. 17, and FIG. 20 is a flowchart illustrating an upgrade package generation procedure of FIG. 17.

Referring to FIGS. 17 to 20, configure files are input to the upgrade package processor 10 in step S551. Each configure file includes flags for defining operations of the upgrade package processor 10. Among the flags, C_FLAG is a compression flag for configuring whether or not to apply data compression, M_FLAG is a map generation flag for configuring whether or not to generate map data, and V_FLAG is a verify flag for verifying whether or not the compression is normally performed by decompressing compressed information. Next, the upgrade package processor 10 loads both the first and second versions of the program in step S553. The first version can be an initial version or a reference version for upgrading the program, and the second version is the last version of the program.

After the two versions of the program are loaded, the upgrade package processor 10 determines whether to compress the first and second versions of the program with reference to the C_FLAG in step S555. If no compression is required, the upgrade package processor 10 formats the two versions of the program to configure versions in step S561 and compares the two versions of the program in step S563. If the C_FLAG is set to 1 (C_FLAG=1), i.e. the data compression is required, the upgrade package processor 10 executes a compressor (compressor_{—}1) in step S557 and controls the compressor to compress the first and second versions of the program in step S559. Next, the upgrade package compressor 10 executes a comparator to compare the two compressed versions in step S563.

The compression procedure at step S559 is performed as shown in FIG. 18. In a case that the compression flag is set, the verify flag is set in general. If the verify flag (V_FLAG) is set, the upgrade package processor 10 decompresses the compressed data and compares the decompressed data to the original data before the compression.

Referring to FIG. 18, after compressing the first and second versions of the program, the upgrade package processor 10 determines if the verify flag is set to 1 (V_FLAG=1) in step S601. If the verity flag is set to 1, the upgrade package processor 10 executes a decompressor (Decompressor_{—}1) to decompress the compressed first and second versions in step S603 and compares the data before and after the compression in step S605. Next, the upgrade package processor 10 verifies a successful compression by determining whether the data before and after the compression are identical with each other in step S607. If the compression is verified, the upgrade package processor 10 notifies the verification results to the comparator 110 in step S609, and otherwise, the upgrade package processor 10 executes an error handling process in step S611.

Returning to FIG. 17, after comparing the first and second versions at step S563, the upgrade package processor 10 executes an install data generator 180 to generate install data in step S565. The install data generator 180 may or may not generate a map depending on the value of M_FLAG. Accordingly, the upgrade package processor 10 determines whether the map flag is set to 1 (M_FLAG=1) in step S567. If the map flag is set to 1, the upgrade package processor controls the comparator 110 to compare the first and second versions in step S569. The data comparison is performed on a block-by-block basis of a predetermined data size. If a block having different data is found in the comparison process, an identical block search is performed for finding the corresponding block of the second version in the search range of the first version. That is, the comparator 110 compares the current block of the second version to each of the blocks in the search range of the first version. The first and second versions are compared in a raw data state or a compressed data state. After completing the comparison, the upgrade package processor 10 controls the comparator 110 to transmit the comparison result to the install data generator 180 in step S571 and save the comparison result in a storage part fur user in generating the map data and upgrade data in step S577. In a case that the map flag is set to 0 (M_FLAG=0), i.e. the map data is not required, the upgrade package processor 10 controls the comparator 110 to compare the first and second versions in step S575 and save the comparison result for use in generating the install data in the storage part in step S577. The first and second versions are compared in a raw data state or a compressed data state. When the map data is required, the upgrade package processor 10 controls to transmit the comparison result to the install data generator 180 and save the comparison result in a storage part for use in generating the map data and the upgrade data. When the map data is not required, the upgrade package processor 10 controls to save the comparison result in the storage part for use in generation of upgrade data.

Next, the upgrade package processor 10 controls the install data generator 180 to generate the install data in step S579. The install data generation procedure is performed as shown in FIG. 19.

Referring to FIG. 19, the upgrade package processor 10 controls the install data generator 180 to start generating the install data in step S651 and checks history data of the first and second versions in step S653. Next, the upgrade package processor 10 runs a history data generator 120 in step S655 to generate the history data in step S657. The history data has a format composed of a header, first input version information, second input version information, and memory information. Each of the first and second input version information is composed of a version identifier (SW VER), a time stamp (SW time stamp), and a checksum (SW checksum). That is, the history data provides information on the version numbers of a reference version (initial version as the first version) and a target version to be upgraded (second version).

After the history data is generated, the upgrade package processor 10 determines if the map flag is set to 1 (M_FLAG=1) in step S659. If the map flag is set to 1, the upgrade package processor 10 runs a map data generator 150 in step S603, and the map data generator 150 generates the map data in step S665. In the case where the first version is required to be upgraded with upgrade data, the map data includes mapping information such as addresses of the upgrade data and upgrade type. The map data is composed of command strings such as copy (C), modify (M), and shift (S), followed by block indexes. The map data are generated on the basis of the comparison result of the first and second versions such that the blocks that are identical to those of a previous version are set with C, the blocks additionally inserted to the previous version or modified from the blocks of the previous version are set to M, and the blocks located at the positions to be occupied by the inserted or modified blocks are set with S. The map data is composed of the block indexes and data indicating the differences between the first and second blocks. In a case where the map data is give as shown in FIG. 19, the block indexes of the second version of the program are #0000 to #1F00. Here, the result of the comparison between the first and second version informs that the blocks #0000 to #0010 and #0024 to #0220 of the first and second version are identical with each other, the blocks #0011 to #0023 and #0221 of the second version are modified, and the blocks #0222 to #1F00 of the second blocks are shifted. In this example, the blocks #0000 to #0010 and #0024 to #0220 of the second version are pasted in the blocks #0000 to #0010 and #0024 to #0220 of the first version, and the block #0221 of the second version is inserted between the blocks #0220 and #0221 of the first version. The map data generator 150 generates the map data composed of the command strings of C:B#0000-B#0010, M:B#00011-B#0023, C:B#0024-B#0220, M:B#0221, and S:[B#0222-B#1F00][B#0221-1EFF]. Here, the upgrade data is composed of the blocks indicated by the M command string. After generating the map data, the upgrade package processor 10 merges the history data and the map data in step S667.

The upgrade package generator 10 generates the install data in accordance with the value of the M_FLAG. The install data is generated with or without the map data according to the value of the M_FLAG at step S661.

Returning to FIG. 17, after the install data are generated, the upgrade package processor 10 executes the package generator 130 in step S581 and the package generator 130 generates the upgrade package in step S583.

FIG. 20 is a flowchart illustrating an upgrade package generation procedure of a program upgrade method according to another exemplary embodiment of the present invention.

Referring to FIG. 20, the upgrade package processor 10 controls the package generator 130 to generate upgrade data on the basis of the comparison result. When blocks identical with the modified blocks of the second version are not found in the first version, the package generator 130 sets the modified blocks as the upgrade data. The positions of the upgrade data relies on the map data. That is, when the blocks of the second version are different from the corresponding blocks of the first version in sizes and data themselves, the blocks are set as the upgrade data and the block indexes of these blocks are set in the M command string.

When the install data has no map data, the package generator 130 can generate the upgrade data having the indexes of the blocks of the second version that are to be combined with the first version. In this case, the upgrade data can be structured in the format having commands C, M, and S.

Preferably, the upgrade data is transmitted in the compressed format. Accordingly, the upgrade package processor 10 executes the compressor 140 in step S623 and controls the compressor to compress the upgrade data in step S625. Sequentially, the upgrade package processor 10 executes the decompressor for decompressing the compression upgrade data in step S627 and controls the comparator to compare the data before and after the compression for verifying the compression in step S629. If the compression is verified at step S631, the upgrade package processor 10 generates an upgrade package by merging the upgrade data and the install data in step S633 and transmits the upgrade package to the upgrade package server 20 in step S635. If the compression failure is detected at step S631, the upgrade package processor 10 performs an error handling process in step S637.

The upgrade package is distributed to the recipient devices 20 in accordance with a download procedure. The upgrade package is composed of the upgrade data generated on the basis of the difference between the first and second version and the install data for installing the upgrade data.

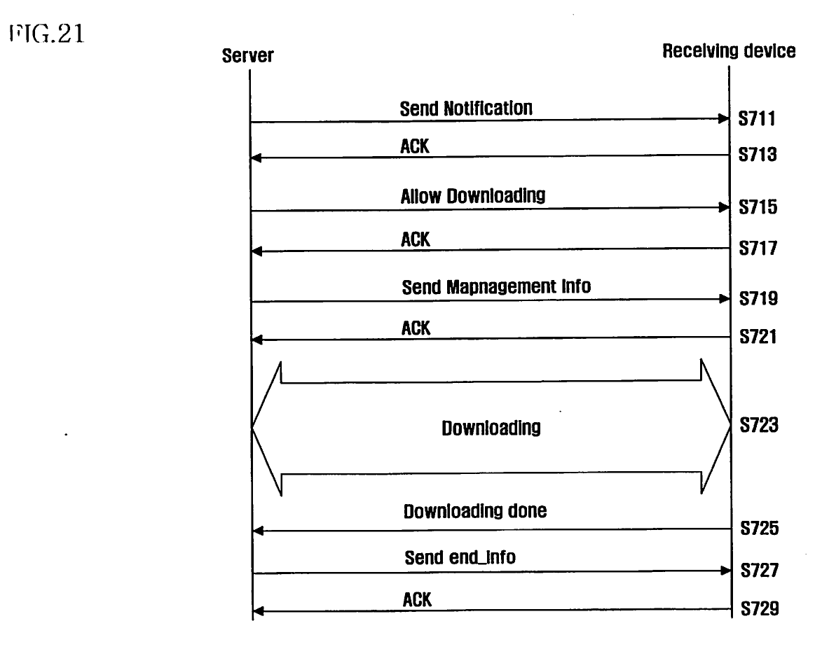

FIG. 21 is a message flow diagram illustrating an upgrade package download procedure of a program upgrade method according to an exemplary embodiment of the present invention. The upgrade package server 20 can be implemented independently or integrated into the upgrade package processor.

Referring to FIG. 21, if an upgrade package is received from the upgrade package processor 10, the upgrade package server 20 transmits a notification message to the recipient device 30 in step S711. The upgrade package server 20 and the recipient device 30 are connected through a cellular network such as CDMA, UMTS, GSM, and GPRS. The recipient device 30 can be a Personal Computer (PC) or a mobile device connected to the personal computer. In this case, the recipient device 30 can be connected to the upgrade package server 20 via Internet by means of a supplementary wireless communication network such as WiBro, WiMAX, and wifi.

In response to the notification message, the recipient device 30 transmits an acknowledgement message (ACK) to the upgrade package server 20 in step S713. Upon receiving the ACK, the upgrade package server 20 transmits a download allowance message to the recipient device in step S715. If an ACK is received from the recipient device in response to the download allowance message, the upgrade package server 20 transmits a management information message to the recipient device 30 in step S719. By transmitting an ACK to the upgrade package server 20 in response to the management information message, the recipient device starts downloading the upgrade package from the upgrade package server 20 in step S723. If the upgrade package is successfully downloaded, the recipient device 30 transmits a download complete message to the upgrade package server 20 in step S725, and the upgrade package server 20 transmits a transmission end information message (send end_info) to the recipient device 30 in step S727. By receiving, at the upgrade package server 20, an ACK from the recipient device 30 in response to the transmission end information message in step S729, the update package download procedure ends.

As described above, the upgrade package server 20 notifies the recipient devices of the issuance of the upgrade package such that the recipient devices download the upgrade package. The recipient device 30 stores the upgrade package downloaded from the upgrade package server 20 into the first memory 250 and starts upgrading a target program in response to a user command such that the upgraded version of the program is loaded on the second memory 260.

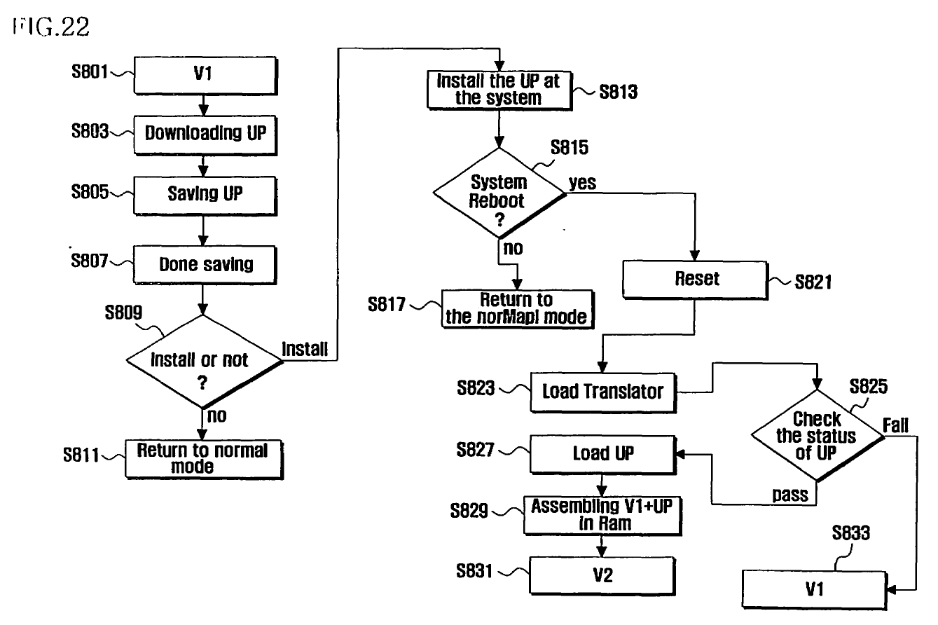

FIG. 22 is a flowchart illustrating a downloaded upgrade package processing procedure of a program upgrade method according to an exemplary embodiment of the present invention.

Referring to FIG. 22, the first version of the program is stored in the first memory 250 of the recipient device 30 in step S801. The first version can be a version installed in the first memory 250 during the manufacturing phase of the recipient device 30 or another version installed later and designated as a reference version. If an upgrade package notification message is received, the recipient device 230 downloads the upgrade package through the procedure depicted in FIG. 21. The recipient device 30 downloads the upgrade package form the upgrade package server 20 and temporarily stores the downloaded upgrade package through steps S803 to S807. The upgrade package can be immediately installed in the first memory 250 or installed after a normal operation of the recipient device 30 ends. After the upgrade package is downloaded, the recipient device 30 determines if an install command is input in step S809. If no install command is input, the recipient device 30 returns to the normal operation mode in step S811.

If an install command is input, the recipient device 30 installs the upgrade package into the first memory 250 in step S813. The first memory 250 is a non-volatile memory and comprises separate regions for storing the first version and multiple upgrade packages. That is, the first memory 250 is composed of the first and second storage regions as shown in FIGS. 9, 10A, and 10B. The upgrade packages are stored in an order of issuance times with such that the upgrade history is secured.

After the upgrade package is installed, the recipient device 30 determines if a system reboot command is input in step S815. If no system reboot command is input, the recipient device 30 returns to the normal operation mode in step S817. In this case, since the program is not upgrade yet, the recipient device 30 operates with the previous version.

If a reboot command input is detected at step S813, the recipient device 30 reboots to be initialized in step S821 and executes the translator 240 for activating the second version from the downloaded upgrade package in step S823. The translator 240 merges the upgrade package installed in the first memory 250 and the first version of the program, and loads the second version on the second memory 260. Accordingly, the recipient device 30 operates with the second version of the program afterward.

Next, the recipient device 30 checks a status of the upgrade package to determine if the upgrade is successfully performed or failed in step S825. If the upgrade failed, the recipient device loads the previous version of the program in step S833. If the upgrade is successfully performed, the recipient device 30 loads the upgrade package in step S827 and assembles the upgrade package and the first version in the second memory 260 in step S829 and then operates with the second version on the second memory in step S831.

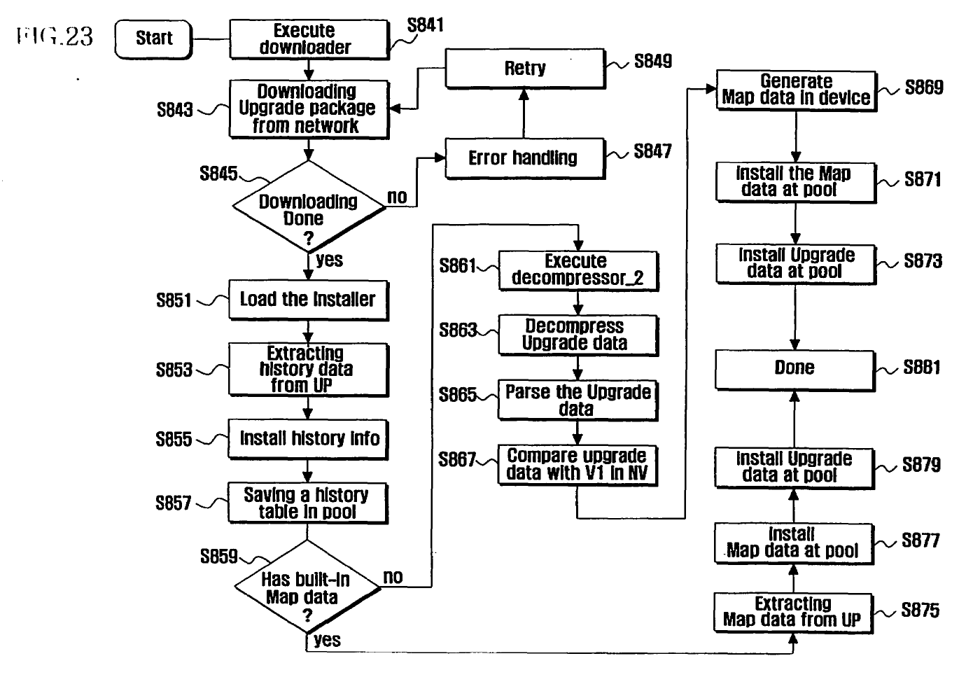

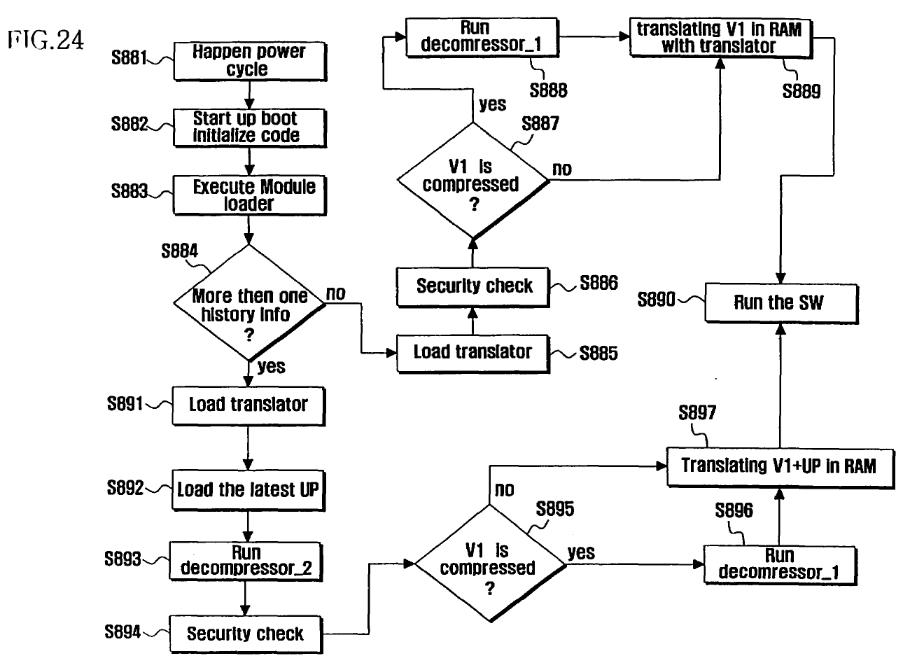

FIG. 23 is a flowchart illustrating an upgrade package install procedure of a program upgrade method according to an exemplary embodiment of the present invention.

Referring to FIG. 23, in an upgrade package download command is input, the recipient device executes a downloader in step S841 and controls the downloader to download the upgrade package from the upgrade package server 20 in step S843. The upgrade package download can be performed in different manner depending on the communication standard supported by the recipient device 30. That is, the recipient device 30 can be a mobile phone operating in a cellular communication standard such as CDMA, UMTS, GSM, and GPRS. Also, the recipient device can be a mobile terminal supporting wireless communication standard such as WiBro, Wifi, and WiMAX. Also, the recipient device 30 can support a short range wireless communication standard such as Bluetooth, UWB, and Zigbee, and wired data communication standard such as USB.

During the download session, the recipient device 30 detects whether an error occurs in step S845. If an error is detected, the recipient device 30 performs an error handling process in step S849 and then retries the download of the upgrade package in step S849.

If the upgrade package is successfully downloaded, the recipient device 30 executes an installer 230 in step S851. Next, the recipient device 30 controls the installer 230 to extract the history data from the upgrade package in step S853, extracts history information from the history data in step S855, and builds a history table in the first memory in step S857. Next, the recipient device 30 detects if map data are packed in the upgrade package in step S859. If map data are packed in the upgrade package, the recipient device 30 extracts the map data from the upgrade package in step S875, stores the map data an upgrade data in corresponding storage parts of the first memory 250 in steps S877 and S879). Consequently, the history data, map data, and upgrade data packed in the upgrade package are installed in the first memory 250 in step S881).

If map data are not packed in the upgrade package, the recipient device 30 executes a decompressor 270 in step S861. Next, the recipient device 30 controls the decompressor 270 to decompress the upgrade data packed in the upgrade package in step S863 and parse the upgrade data in step S865. Next, the recipient device 30 compares the upgrade data with the first version in the first memory 250 in step S867 and generates map data with reference to the comparison result in step S869. Next, the recipient device 30 stores the map data generated in the recipient device and the upgrade data packed in the upgrade package into the upgrade package storage part of the first memory in steps S871 and S873.

As depicted in FIG. 23, the recipient device 30 downloads the upgrade package and installs the history data, map data, and upgrade data packed in the upgrade package within corresponding storage regions of the first memory 250. At this time, the map data may or may not be packed in the upgrade package. When no map data is packed in the upgrade package, the recipient device 30 stores the upgrade package within the first memory 250 and compares the upgrade package with the first version so as to generate map data on the basis of the comparison analysis and store the map data in the upgrade package storage part.

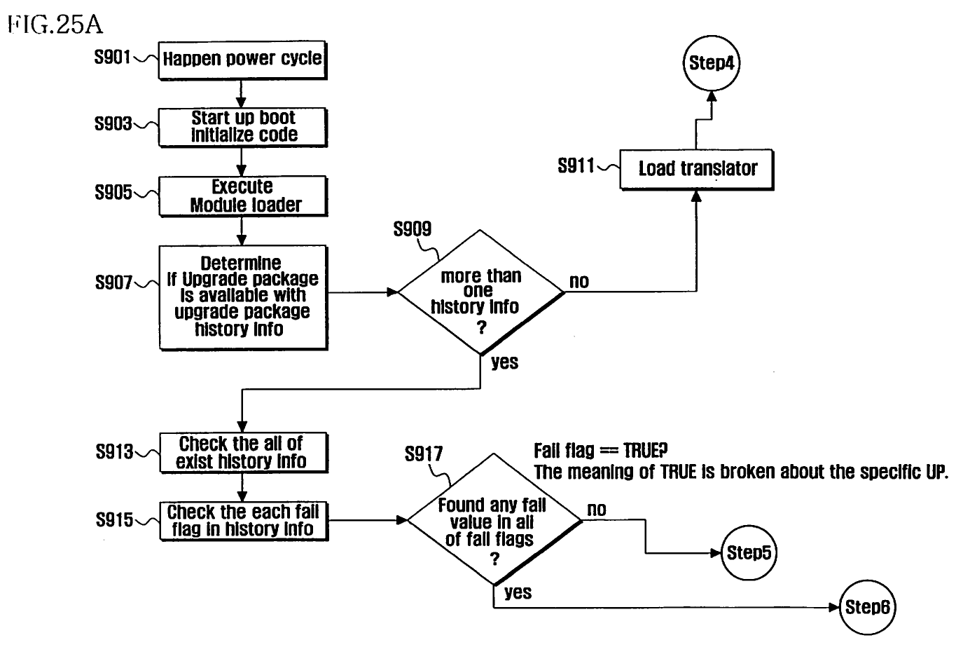

FIG. 24 is a flowchart illustrating an upgraded program running procedure of a program upgrade method according to an exemplary embodiment of the present invention.

Referring to FIG. 24, the upgraded program is enabled when the recipient device 30 is turned on so as to be initialized or in response to a user command. That is, after the recipient device 30 is initialized, the second version of the program, upgraded by combining the first version and the lastly downloaded upgrade package (or a specific upgrade package selected by the user), is loaded on the second memory 260 such that the recipient device 30 operates with the second version of the program. The information loaded on the second memory 260 is represented by a program and its equivalents that can be installed in a volatile memory.

If the recipient device 20 is turned on in step S881, the recipient device 30 starts booting the system and initializes codes in step S882 and executes a loader in step S883. Next, the recipient device 30 scans the upgrade package storage parts of the first memory 250 and checks the upgrade packages in step S884. If no upgrade package exists, the recipient device 30 executes the translator 240 in step S885 and controls the translator 240 to perform security checks including virus check in step S886. Next, the recipient device 30 determines if the first version stored in the first memory 250 is compressed in step S887. If it is determined that the first version is compressed, the recipient device 30 runs the decompressor 270 to decompress the first version in step S888 and controls the translator 240 to translate the first version in the second memory 260 in step S889 such that the first version of the program runs. If it is determined that the first version is not compressed at step in step S887, the recipient device 30 skips step S888 and performs steps S889 and S890.

Returning to step S884, if at least one upgrade package exists in the first memory 250, the recipient device 30 executes translator 240 in step S891 and loads the recently downloaded upgrade package in step S892. The upgrade package can be composed of at least two of the history data, map data, and upgrade data.

Next, the recipient device 30 runs the decompressor 270 to decompress the loaded upgrade package (here, only the upgrade data may be compressed) in step S893 and performs a security check in step S894. Next, the recipient device 30 determines if the first version stored in the first memory 250 is compressed in step S895. If it is determined that the first version is compressed, the recipient device 30 runs the decompressor 270 to decompress the first version in step S896 and controls the translator 240 to translate and combine the first version and the upgrade package in the second memory 260 in step S897 such that the upgraded version of the program runs in step S890. If it is determined that the first version is not compressed at step in step S895, the recipient device 30 skips step S896 and performs steps S897 and S890.

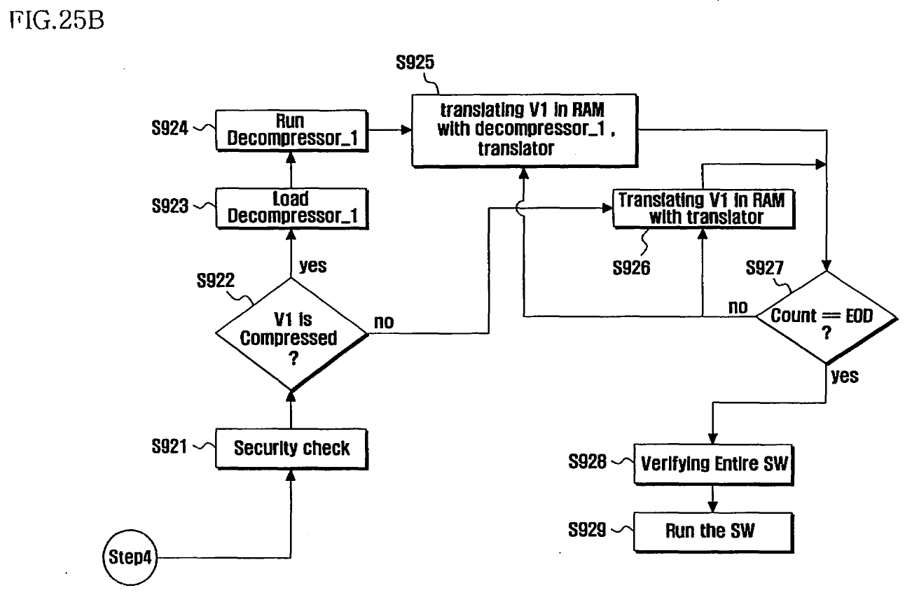

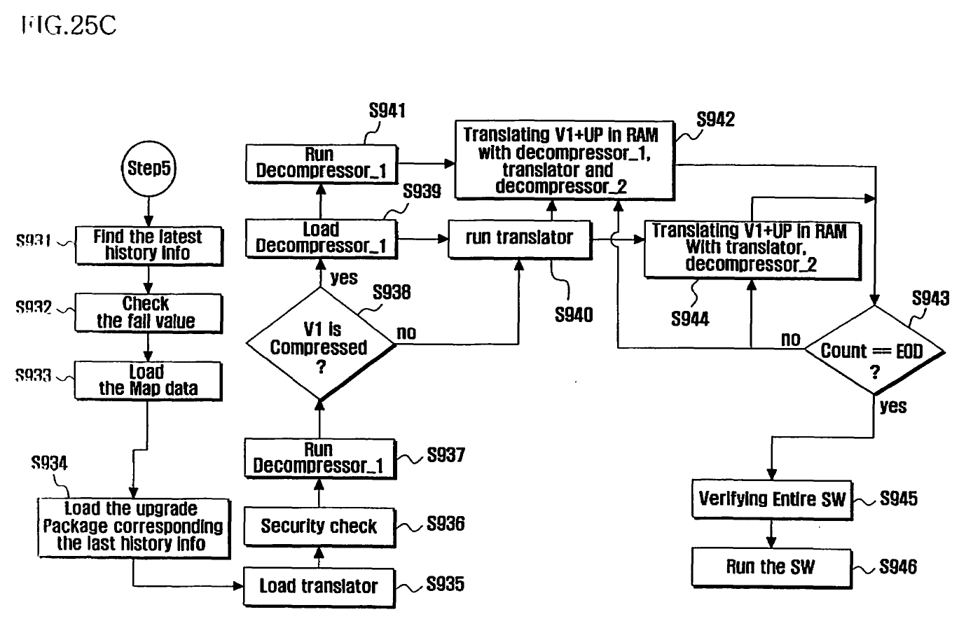

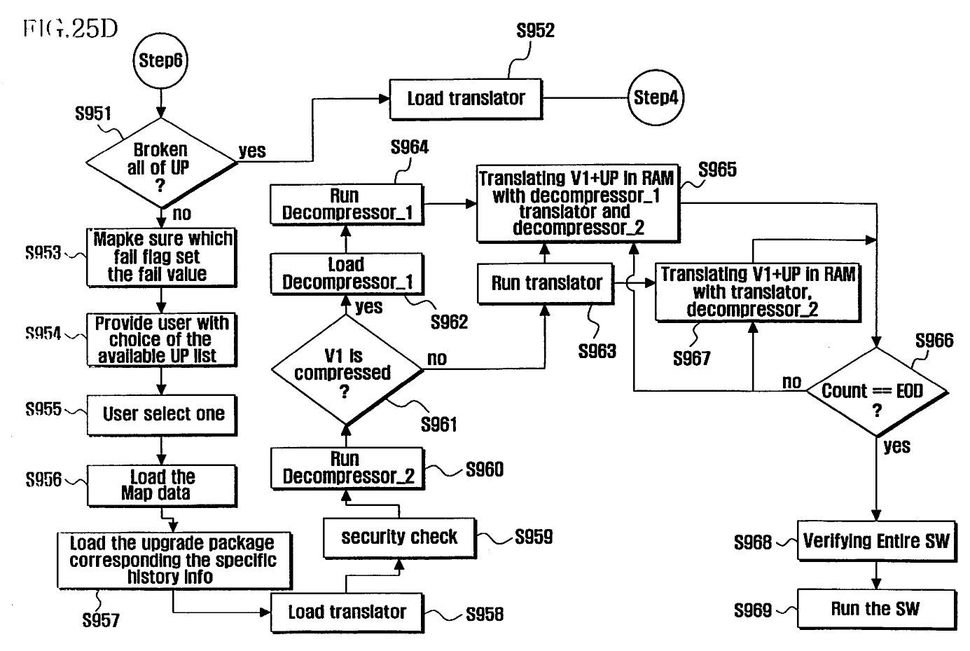

FIGS. 25A to 25D are flowcharts illustrating an upgrade program running procedure of a program upgrade method according to another exemplary embodiment of the present invention.

Referring to FIGS. 25A to 25D, if the recipient device 30 is turned on in step S901, the recipient device 30 starts booting the system and initializes codes in step S903 and executes a loader in step S905. Next, the recipient device 30 determines if any upgrade package is available with reference to the history of upgrade package in step S907, and checks the upgrade packages in step S909. If no upgrade package exists, the recipient device 30 executes the translator 240 in step S911 and performs security check in step S921 (see FIG. 25B). Next, the recipient device 30 determines if the first version stored is compressed in step S922. If it is determined that the first version is compressed, the recipient device 30 runs the decompressor (decompressor_{—}1) 270 and the translator in steps S923 and S924 and controls the decompressor and the translator to cooperatively decompress and translate the first version in step S925. While decompressing and translating the data of the first version, the recipient device 30 monitors the processes to detect if the first version is completely translated, using a counter (Count=EOD) in step S927. The decompression and translation processes are repeated until the counter reaches the end of the data (EOD) (count=EOD) in the second memory 260. If it is determined that the first version of the program is not compressed at step S922, the recipient device 30 controls the translator to translate the first version in the second memory 260 without decompression in step S926 until the counter reaches the end of the data. If the counter reaches the EOD, the recipient device 30 verifies the entire data of the translated first version of the program in step S928 and runs the first version for operating the system.

Returning to FIG. 25A, if at least one upgrade package exists in the first memory 250 at step S909, the recipient device 30 inspects the history information of all the upgrade packages in step S913 and checks fail flags in the history information in step S915. The fail flag indicates if loading the upgrade package has failed. If the fail flag is set to true (fail flag=true), the upgrade package has failed. For this reason, the recipient device 20 determines if the fail flag of the history information of upgrade package is set to “true” in step S917. If the fail flag is not set to “true,” the recipient device 30 performs the program upgrade procedure through steps S931 to S946 of FIG. 25C. In contrast, if the fail flag is set to “true,” the recipient device 30 performs the program upgrade procedure through steps S951 to S969 of FIG. 25D.

As shown in FIG. 25C, if the fail flag is not set to “true,” the recipient device 30 checks the history data of the latest upgrade packages in step S321 and checks the fail flag of the history data in step S932. If the fail flag is not set to “true,” the recipient device 30 loads the map data and upgrade data of the upgrade package in steps S933 and S934. Next, the recipient device 30 loads the translator in step S935, performs security checks in step S936, and loads the decompressor (Decompressor_{—}1) in step S937. Next, the recipient device 30 determines if the first version of the program is compressed in step S938. If the first version is compressed, the recipient device 30 runs the decompressor and the translator in steps S939, S940, and S941. Next, the recipient device 30 controls the first and second decompressors and the translator to decompress and translate the first version and the upgrade package in the second memory 260 in step S942. While decompressing and translating the data of the first version and the upgrade package, the recipient device 30 monitors the processes to detect whether the process is completed with reference to a counter (Count=EOD) in step S943. The decompression and translation processes are repeated until the counter reaches the EOD. If it is determined that the first version is not compressed at step S938, the recipient device 30 runs the translator in step S940 and controls the translator to translate the data of the first version and the upgrade package in the second memory without decompression process in step S944 until the counter reaches the EOD. If the counter reaches the EOD, the recipient device 30 verifies the entire data of the translated first version and the upgrade package in step S945 and runs the upgrade version of the program for operating the system in step S946.

As shown in FIG. 25D, if the fail flag is set to “true,” at step S917 of FIG. 25A, the recipient device 30 checks if all fail flags of the upgrade packages are set to “true” in step S951. If all the fail flags are set to “true,” the recipient device 30 loads the translator in step S925 and performs step S921. That is, if all the upgrade packages have errors, the recipient device 30 loads the first version of the program on the second memory 260 such that the recipient device 30 operates with the first version. That is, if all the upgrade packages are erroneous, the recipient device 30 loads the first version of the program stored in the first memory 250 on the second memory 260 such that the recipient device 30 operates with the first version of the program. The first version may be an original version of the program installed during the manufacturing phase.

If not the all fail flags of the upgrade package are set to “true,” the recipient device 30 checks the upgrade packages of which fail flags are not set to “true” in step S953 and displays available upgrade packages in step S954. If a selection command is input for selecting one of the available upgrade packages in step S955, the recipient device 30 loads the map data and upgrade data of the selected upgrade package in association with the history information in steps S956 and S957. Next, the recipient device 30 executes the translator in step S956 and performs security check on the data in step S959. Next, the recipient device 30 runs the decompressor (Decompressor_{—}2) for decompressing, if the upgrade data are compressed, the upgrade data in step S960. Next, the recipient device 30 determines if the first version of the program is compressed in step S961. If the first version is compressed, the recipient device 30 runs the first decompressor (Decompressor_{—}1) and the translator in steps S962, S963, and S964. Next, the recipient device 30 controls the first and second decompressors and the translator to decompress and translate the first version and the upgrade package in the second memory 260 in step S965. While decompressing and translating the data of the first version and the upgrade data, the recipient device 30 monitors the processes to detect whether the process is completed with reference to the EOD (Count=EOD) in step S966. The decompression and translation process are repeated until the counter reaches the EOD.

As described above, in the program upgrade method according to an embodiment of the present invention, the upgrade package provider generates an upgrade package in accordance with differences between old and new versions of a target program, and the recipient device downloads and upgrades the old version to the new version such that the upgraded new version of the program loaded in the non-volatile memory is loaded in the volatile memory for operating the recipient device.

In the upgrade package processor 10, the upgrade package is generated by, so called, an upgrade module generation or delta generation module. The upgrade package processor 10 uses a code compressor as the first compressor 160, which compresses differences between the data of the first and second versions in an uncompressed state. The first compressor 160 compresses the differences between the first and second versions (domain: V1 (previous frame), range: V2 (current frame)).

The upgrade package generation module is characterized by a high compression ratio (over 99% on average), a very fast update time (faster than the file loading time), and a fast generation time.

The upgrade package generation mechanism has the following characteristics.

If two versions of the program are input, the upgrade package processor compares the two versions and generates a comparison result data using the differences between the two versions. Here, the first version is a reference version which can be a program installed during the manufacturing phase or a program decided afterward. The second version is an upgraded version of the program to be downloaded by the recipient device for upgrading the first version of the program. Multiple upgrade versions can be issued, so the second version can be one of the upgrade versions, particularly, the latest version.

The two versions can be compared before or after being compressed. In the case of comparison after compression, a compression verification process can be performed by decompressing each compressed version and comparing the data before and after the compression.

The install data is generated on the basis of the comparison result data. The install data is the data providing information on how to map the update data to the first version. The install data must include history data. The history data includes version identifiers of the first and second versions and a flag indicating a history of loading failures of the upgrade package. The install data can include map data in addition to the history data. The map data is data that includes block indexes and how to map the update data (the blocks) to the first version. The map data is provided with commands such as “copy”, “modify”, and “shift”, each followed by block indexes for processing the blocks in relation to the first version. In the case that the install data has no map data, the recipient device 30 can produce the map data with reference to the data of the first version and the upgrade data of the upgrade package.

After the install data is generated, the upgrade data is generated on the basis of the comparison result.

The upgrade data is set by the blocks of which data is different from each other as a result of comparison of the first and second version on a block-by-block bases. At this time, the block indexes of the blocks corresponding to the upgrade data can be contained in the M command string. The upgrade data is merged with the install data such that the upgrade package is generated. The install data can be generated without the map data. In this case, the map data is generated at the recipient device 30.

The upgrade data or the upgrade package can be provided in a compressed format. In this case, the upgrade package processor 10 verifies the compression by decompressing the compressed upgrade data or the compressed upgrade package and comparing the data before and after compression.

The upgrade package generated in the above manner is transmitted to the upgrade package server 20, and the upgrade package server 20 notifies the recipient device 30 of the issuance of the upgrade package such that the recipient device downloads the upgrade package.

The first memory 250 of the recipient device 30 stores the first version of the program and at least one upgrade package downloaded from the upgrade package server 20. The first version is a initial version of the program or a specific program installed later as a reference program. The upgrade package includes upgrade data and map data. The upgrade data is the data that is required for the second version but does not exist in the first version, and the map data includes command strings composed of commands such as C, M, and S, each followed by block indexes of which blocks are processed according to the commands. In the first memory 250, multiple upgrade packages can be stored (in this embodiment, 6 upgrade package can be stored). The first memory 250 can be configured such that, when there is no empty storage part and a new upgrade package is downloaded, the new upgrade package is overwritten. The map data can be carried by the upgrade package or generated at the recipient device 30.

The target program is upgraded by loading the first version and the upgrade package on the second memory 260.

Preferably, the first memory is a nonvolatile memory, and the second memory is a volatile memory. A modification package is generated by copying a first version package onto the second memory 260 or updating the first version package using an upgrade package. In the latter case, the first version package is loaded on the second memory 260 and then updated by the upgrade package such that the modification package is generated. The package update can be performed with the above-described commands “copy”, “modify”, and “shift”. The package update is managed by the loader. The loader controls the cooperative operations of modules such as an assembler, a decompressor, and a user interface, when the recipient device is rebooted.

If the upgrade package is successfully generated, the recipient device operates with the upgrade package.

The program upgrade can be decided by the user. In this case, one of the upgrade packages is selected by the user and the program is upgraded using the selected upgrade package. That is, the recipient device 30 displays an upgrade package list such that the user can select one of the upgrade packages listed on the upgrade package list. Since multiple upgrade packages are independently stored in the first memory, the program upgrade can be retried when the program upgrade has failed with a specific upgrade package.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

As described above, in the program upgrade system and method of the present invention, an upgrade package generated on the basis of the differences between a reference version and a new version of a program, resulting in fast upgrade package generation. Since the first version and the upgrade package downloaded from a network are separately installed in a non-volatile storage and loaded as an upgrade version on the volatile storage, it is possible to secure operability of the program even in an upgrade failure situation. Also, the program upgrade system and method of the present invention enable separately storing multiple upgrade packages in a non-volatile storage, it is possible to operate the recipient device with a user-preferable version of the program.

Furthermore, since the upgrade procedure is performed on a memory separated from the memory in which the first version and the upgrade packages of the program are stored, a fault tolerant control function works implicitly. Accordingly, the program upgrade system and method of the present invention are advantageous since the operation stability is secured even when the program upgrade fails with an upgrade package.

What is claimed is:

1. An information upgrade method in a network, comprising:
generating an upgrade package on the basis of differences between a first and second versions of the program at an upgrade package processor;
notifying at least one recipient device of an issuance of an upgrade package to the upgrade package server;
downloading the upgrade package from the upgrade package server at the recipient device;
storing the upgrade package in a first memory;
generating the second version by merging the upgrade package and the first version previously stored in the first memory; and
loading the second version on a second memory in response to an upgrade command.

2. The information upgrade method of claim 1, wherein the upgrade package includes history data for merging the first version and the upgrade package, upgrade data to be combined with data of the first version, and map data for mapping the upgrade data to the first version.

3. The information upgrade method of claim 2, wherein the map data comprises at least one command string composed of a command followed by at least one block index indicating a block to which the command is executed, the command being a copy command for copying at least one block from the first version, a modify command for adding at least one new block to the first version or modifying at least one block of the first version, and a shift command for shifting at least one block following the block applied by the modified command, the upgrade data being the block indicated by the block index followed by the modified command.

4. The information upgrade method of claim 3, wherein generating the upgrade package comprises:
comparing the first and second versions of the information in unit of block;
generating the upgrade data with reference to the block indexes followed by the modify command of the map data; and
producing the upgrade package by packing the history data, the map data, and the upgrade data.

5. The information upgrade method of claim 3, wherein comparing the first and second versions comprises:
compressing the first and second versions in unit of block of a predetermined size;
comparing the first and second versions in unit of compressed blocks;
generating the upgrade data with reference to the block indexes followed by the modify command of the map data; and
producing the upgrade package by packing the history data, the map data, and the upgrade data

6. The information upgrade method of claim 5, further comprising compressing the upgrade package.

7. The information upgrade method of claim 3, wherein generating second version comprises:
storing the upgrade package within a nonvolatile memory that includes a plurality of storage regions for storing the first version and the upgrade package;
generating the second version by mapping the upgrade package to the first version; and
loading the second version on a volatile memory.

8. The information upgrade method of claim 7, wherein generating the second version comprises:
analyzing the map data;
copying the blocks indicated by the block indexes following the copy command from the first version if the map data contain the copy command string;
shifting the blocks indicated by the block indexes following the shift command in the first version if the map data contain the shift command string; and
inserting the blocks indicated by the block indexes following the modify command into corresponding positions of the first version if the map data contain the modify command string.

9. The information upgrade method of claim 8, wherein the upgrade command is generated by a key input or by an initialization of the recipient device.

10. The information upgrade method of claim 8, wherein the information is a program.

11. A program upgrade method in a network including an upgrade package processor for generating an upgrade package for a program and an upgrade package server allowing a recipient device to download the upgrade package, comprising:
generating the upgrade package on the basis of differences between a first and second versions of the program at the upgrade package processor;
notifying at least one recipient device of an issuance of the upgrade package at the upgrade package server;
downloading the upgrade package from the upgrade package server at the recipient device;
storing the upgrade package in a non-volatile memory;
generating the second version of the program by merging the upgrade package and the first version previously stored in the non-volatile memory; and
loading the second version on a volatile memory in response to an upgrade command,
wherein generating the upgrade package comprises:
comparing the first and second versions of the program in unit of block;
generating the upgrade data on the basis of a comparison result;
generating install data for installing the upgrade data on the basis of the comparison result; and
producing the upgrade package by packing the install data and the upgrade data.

12. A program upgrade method in a network including an upgrade package processor for generating an upgrade package for a program and an upgrade package server allowing a recipient device to download the upgrade package, comprising:
generating the upgrade package on the basis of differences between a first and second versions of the program at the upgrade package processor;
notifying at least one recipient device of an issuance of the upgrade package at the upgrade package server;
downloading the upgrade package from the upgrade package server at the recipient device;
storing the upgrade package in a non-volatile memory; and
generating the second version of the program by merging the upgrade package and the first version previously stored in the non-volatile memory; and
loading the second version on a volatile memory in response to an upgrade command,
wherein generating the second version of the program comprises:
storing the downloaded upgrade package in the first memory; and
producing the second version by loading and merging the first version and the upgrade package in response to the upgrade command.

13. A program upgrade method in a network including an upgrade package processor for generating an upgrade package for a program and an upgrade package server allowing a recipient device to download the upgrade package, comprising:
receiving the first and second versions at the upgrade package processor;
comparing the first and second versions;
generating upgrade data to be merged with the first version;
generating install data for instructing how to merging the upgrade data and the first version;
generating the upgrade package by packing the upgrade data and the install data;
notifying at least one recipient device of an issuance of the upgrade package at the upgrade package server;
downloading the upgrade package from the upgrade package server at the recipient device;
installing the downloaded upgrade package in a nonvolatile memory;
generating the second version of the program by merging the first version and the upgrade package in response to an upgrade command; and
loading the second version on a volatile memory for operating the recipient device.

14. A program upgrade system comprising:
an upgrade package processor for generating an upgrade package on the basis of difference between a first and second versions of a program;
an upgrade package server for receiving the upgrade package from the upgrade package processor and broadcasting an advertisement for notifying an issuance of the upgrade package; and
at least one mobile device for downloading the upgrade package in response to the advertisement, storing the upgrade package in a first memory in which the first version is stored, generating the second version by merging the upgrade package and the first version, and loading the second version on a second memory for operating the mobile device.

15. The program upgrade system of claim 14, wherein the upgrade package processor comprises:
an install data generator for generating install data composed of a history data providing information how to merge the first version and the upgrade package and map data proving information how to map the upgrade package to the first version; and
a package generator for generating upgrade data on the basis of the map data and producing the upgrade package by packing the install data and the upgrade data.

16. The program upgrade system of claim 15, wherein the map data comprises at least one command string composed of a command followed by at least one block index indicating a block to which the command is executed, the command being a copy command for copying at least one block from the first version, a modify command for adding at least one new block to the first version or modifying at least one block of the first version, and a shift command for shifting at least one block following the block applied by the modified command, the upgrade data being the block indicated by the block index followed by the modified command.

17. The program upgrade system of claim 14, wherein the upgrade package processor further comprises a comparator for comparing the first and second versions in unit of block, the upgrade package processor generating the upgrade data with the blocks indicated by the block indexes following the modify command.

18. The program upgrade system of claim 17, wherein the upgrade package processor further comprises a compressor for compressing the first and second versions in unit of block of a predetermined size.

19. The program upgrade system of claim 18, wherein the upgrade package processor further comprises a second compressor for compressing the upgrade package.

20. The program upgrade system of claim 18, wherein the mobile device comprises:
a first memory having a first storage region for storing the first version and a second storage region for storing at least one upgrade package;
a second memory for loading the second version.
an installer for installing the downloaded upgrade package in an upgrade package storage region of the first memory; and
a translator for generating the second version by mapping the upgrade package to the first version in response to an upgrade command and loading the second version on the second memory.

21. The program upgrade system of claim 20, wherein the translator loads the map data and upgrades the first version to the second data by copying at least one block indicated by the block index following the copy command for the second version, adding at least one block as the upgrade data indicated by the block index following the modify command, and shifting at least one block indicated by the block index following the shift command.

22. The program upgrade system of claim 21, wherein the upgrade command is generated by a key input for selecting an upgrade package from at least one upgrade package listed and displayed by the mobile device.

23. The program upgrade system of claim 21, wherein the upgrade command is generated by an initialization process by a system reboot of the mobile device.

24. A program upgrade system comprising:
an upgrade package processor for generating an upgrade package on the basis of difference between a first and second versions of a program;
an upgrade package server for receiving the upgrade package from the upgrade package processor and broadcasting an advertisement for notifying an issuance of the upgrade package; and
at least one mobile device for downloading the upgrade package in response to the advertisement, storing the upgrade package in a first memory in which the first version is stored, generating the second version by merging the upgrade package and the first version, and loading the second version on a second memory for operating the mobile device,
wherein the upgrade package processor comprises:
a comparator for comparing the first and second versions;
an install data generator for generating install data on the basis of the comparison result; and
a package generator for generating upgrade data on the basis of the map data and producing the upgrade package by packing the install data and the upgrade data.

25. A program upgrade system comprising:
an upgrade package processor for generating an upgrade package on the basis of difference between a first and second versions of a program;
an upgrade package server for receiving the upgrade package from the upgrade package processor and broadcasting an advertisement for notifying an issuance of the upgrade package; and
at least one mobile device for downloading the upgrade package in response to the advertisement, storing the upgrade package in a first memory in which the first version is stored, generating the second version by merging the upgrade package and the first version, and loading the second version on a second memory for operating the mobile device,
wherein the mobile device comprises:
an installer for installing the downloaded upgrade package in an upgrade package storage region of the first memory; and
a translator for generating the second version by mapping the upgrade package to the first version in response to an upgrade command and loading the second version on the second memory.

26. A program upgrade system comprising:
an upgrade package processor having a comparator for comparing a first and second versions of a program;
an install data generator for generating install data informing how to upgrade the first version to the second version;
a upgrade package generator for generating upgrade data on the basis of the comparison result and producing an upgrade package by packing the install data and the upgrade data;
an upgrade package server for receiving the upgrade package from the upgrade package processor and broadcasting an advertisement for notifying an issuance of the upgrade package; and
at least one mobile device having a first memory for storing the first version and at least one upgrade package, a second memory for storing the second version produced using the first version and the upgrade package, an installer for installing the upgrade package downloaded from the upgrade package server within one of upgrade package storage regions of the first memory, and a translator for generating the second version by mapping the upgrade package to the first version and loading the second version on the second memory.
